(19) United States
(12) Patent Application Publication
(10) Pub. No.: US 2001/0046021 A1
(43) Pub. Date: Nov. 29, 2001

(54) A CONDUCTIVE PARTICLE TO CONDUCTIVELY BOND CONDUCTIVE MEMBERS TO EACH OTHER, AN ANISOTROPIC ADHESIVE CONTAINING THE CONDUCTIVE PARTICLE, A LIQUID CRYSTAL DISPLAY DEVICE USING THE ANISOTROPIC CONDUCTIVE ADHESIVE, A METHOD FOR MANUFACTURING THE LIQUID CRYSTAL DISPLAY DEVICE

(76) Inventors: TAKESHI KOZUKA, MINAMIASHIGARA-SHI (JP); TSUTOMU YAMAZAKI, SAYAMA-SHI (JP); IKUMI SAKATA, SAYAMA-SHI (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/141,021

(22) Filed: Aug. 27, 1998

(30) Foreign Application Priority Data
Aug. 28, 1997 (JP) 9-247775
Aug. 28, 1997 (JP) 9-247791
Aug. 28, 1997 (JP) 9-247798

(51) Int. Cl. G02F 1/1345

(52) U.S. Cl. 349/150

(57) ABSTRACT

A conductive particle used for an anisotropic conductive adhesive provides an anisotropic conductive bonding between terminal electrodes without deforming a wiring pattern or the terminal electrode of a circuit board. A conductive layer is formed on a surface of a core particle of the conductive particle. The conductive particle has a yield point within a range of degree of deformation from 5% to 40% so that a modulus of compressive deformation of the conductive particle drastically increases at the yield point.

### BACKGROUND OF THE INVENTION

1. Field of the Invention

The present invention generally relates to a conductive adhesive and, more particularly, to an anisotropic conductive adhesive used for conductively bonding conductive members to each other. Such an anisotropic conductive adhesive is used for bonding two circuit boards to each other in a state in which wiring patterns of the circuit boards are opposite to each other so that the wiring patterns are conductively bonded to each other.

The present invention also relates to a conductive particle contained in the anisotropic conductive adhesive. The present invention further relates to a liquid crystal display device using the above-mentioned anisotropic conductive adhesive and a method for manufacturing such a liquid crystal display device.

2. Description of the Related Art

Conventionally, an anisotropic conductive material is used for attaching circuit boards to each other so that a wiring pattern of one of the circuit boards adheres to a wiring pattern of the other while maintaining insulation between the wiring patterns of the same circuit board. Such an anisotropic conductive adhesive may be provided in the form of an anisotropic conductive film or layer. The anisotropic conductive film generally contains conductive particles dispersed in an adhesive component such as a binder having a heat adhesion characteristic and an electric insulation characteristic.

The anisotropic conductive film is interposed between two wiring boards in a state in which wiring patterns formed on the wiring boards are opposed to each other. Then, the two wiring boards are subjected to thermal-compression bonding, that is, the wiring boards are heated while being pressed against each other. In this state, the anisotropic conductive film is softened and an insulating adhesive in a portion of the film between the opposed wiring patterns is displaced transversely and the opposed wiring patterns are conductively connected to each other by the conductive particles. That is, the two wiring boards are connected by means of an anisotropic conductive adhesion.

In such an anisotropic conductive adhesive, a metal particle is used as a conductive particle. Alternatively, a hard resin particle coated by conductive material (conductive metal film) can be used. Such a conductive particle has a high hardness, and thereby the conductive particle contacts the wiring pattern at a point (point contact).

There is a case in which a glass plate is used as a base of each circuit board and the wiring patterns are formed on the glass plate. In such a case, when the circuit boards are heated and pressed with the anisotropic conductive adhesive therebetween, the wiring patterns are not damaged by the conductive particles contained in the anisotropic conductive adhesive.

However, in a liquid crystal display device, a relatively flexible resin film has become popular as a base of a circuit board on which wiring patterns are formed. That is, use of a relatively flexible material such as in a flexible printed-circuit board has been increased. Additionally, the resin film board (flexible board) such as one used in the liquid crystal display device has an electrode for external connection in addition to the wiring patterns, the electrode being formed on a periphery of the resin film board.

There is a case in which two flexible circuit boards are to be bonded or attached to each other in a state in which the wiring patterns formed on the flexible circuit boards are opposed to each other so that the wiring patterns on the flexible circuit boards are conductively connected to each other. Additionally, there is a case in which the terminal electrode for external connection which is exposed on a periphery of the flexible circuit board is to be bonded to a terminal electrode formed on a flexible circuit board of other devices. In such cases, if a thermal-compression bonding process is performed with the above-mentioned anisotropic conductive adhesive containing hard conductive particles, the electrode may be damaged by the hard conductive particles. Accordingly, there is a problem in that a good conductivity cannot be maintained.

Specifically, the conductive particle generally used in the anisotropic conductive adhesive has a diameter of about 2 to 30 μm, and comprises a core particle made of a polymer and a conductive layer formed around the core particle. The thus-constructed conductive particle has a very high hardness, and it is hard to crush the conductive particle by a pressure (normally about 45 kg/cm²) applied for curing the anisotropic conductive adhesive by pressing with heat. If an attempt is made to deform the thus-constructed conductive particle beyond its limit of elasticity, there is a problem in that the wiring pattern formed on the circuit board or the terminal electrode formed on a periphery of the circuit board may be deformed or damaged by the pressure. Additionally, if the base of the circuit board is made of a film material, there is a problem in that the film itself is destroyed by the pressure.

Additionally, it is possible that an insulating adhesive component may remain between the conductive particle and a wiring pattern or a terminal electrode after the anisotropic conductive adhesive is cured. Thus, there is a problem in that a good conductivity cannot be obtained between the conductive particle and the wiring pattern or the terminal electrode due to the insulating adhesive component remaining therebetween.

Additionally, there is a case in which the anisotropic conductive adhesive is used to bond terminal electrodes for external connection of a liquid crystal display device using a resin-base board to terminal electrodes of a flexible wiring board of a device such as a drive circuit device for driving the liquid crystal display device. In such a case, there is a problem in that a good anisotropic conductive connection cannot be obtained between the terminal electrodes when a pitch between the terminal electrodes of the liquid crystal display device is very small, such as about 200 Ξm.

That is, when the pitch of the terminal electrodes is as small as about 200 μm, the existing anisotropic conductive adhesive may short-circuit the adjacent terminal electrodes.

### SUMMARY OF THE INVENTION

It is a general object of the present invention to provide an improved and useful anisotropic conductive adhesive in which the above-mentioned problems are eliminated.

A more specific object of the present invention is to provide a conductive particle which can be used for an anisotropic conductive adhesive providing a good conductive connection without deforming a wiring pattern or a terminal electrode of a circuit board.

Another object of the present invention is to provide a conductive particle which can be used for an anisotropic conductive adhesive providing a good conductive connection by preventing an insulating adhesive component from remaining between the conductive particle and a wiring pattern or a terminal electrode after the anisotropic conductive adhesive has been cured.

A further object of the present invention is to provide an anisotropic conductive adhesive which can prevent adjacent terminal electrodes from being short-circuited even when a pitch of the terminal electrodes is as small as 200 μm.

In order to achieve the above-mentioned objects, there is provided according one aspect of the present invention a conductive particle for an anisotropic conductive adhesive, comprising:

a core particle; and

a conductive layer formed on a surface of the core particle,

wherein the conductive particle has a yield point within a range of degree of deformation from 5% to 40%, a modulus of compressive deformation of the conductive particle drastically increasing at the yield point.

Additionally, there is provided according to another aspect of the present invention a conductive particle for an anisotropic conductive adhesive, comprising:

a core particle; and

a conductive layer formed on a surface of the core particle,

wherein the conductive particle shows a characteristic of a hard elastic sphere until a compression force reaches 2 gf/particle to 3 gf/particle at an ordinary temperature, and the conductive particle crushes and begins to plastically deform when the compression force reaches 2 gf/particle to 3 gf/particle.

Further, there is provided according to another aspect of the present invention a conductive particle for an anisotropic conductive adhesive, comprising:

a core particle made of a resin material; and

a conductive layer formed on an entire surface of the core particle, the conductive layer being formed by metal coating,

wherein the core particle has a yield point within a range of a compression force from 2 gf/particle to 3 gf/particle, a modulus of compressive deformation of the conductive particle drastically increasing so that the conductive particle starts to crush and plastically deform at the yield point.

According to the above-mentioned invention, the conductive particle can be crushed or deformed by a small increase in a compression force applied to the conductive particle after a degree of deformation due to the compression force exceeds 5% to 40% or after the compression force reaches 2 gf/particle to 3 gf/particle. Accordingly, when the conductive particle is used in an anisotropic conductive adhesive for bonding a conductive member such as a wiring board including a flexible base board and electrodes formed on the flexible base board, the conductive particle does not damage the electrodes or the flexible base board even if the conductive particle is pressed against the wiring board with an excessive force. Additionally, the deformation of the conductive particle provides an increased contact surface between the conductive particle and the electrodes, which results in a good conductivity of the anisotropic conductive adhesive.

In the conductive particle according to the present inveniton, when a compressive elastic deformation characteristic K of the conductive particle is defined as K=(3/2^{½})·(S^{-3/2})·(R^{-½})·F, a value of K may be set to 10 to 100 (kgf/mm²) when a degree of compressive deformation of the conductive particle is 40%, where F is a compression force (kgf), S is a compression strain (mm) and R is a radius (mm) of the conductive particle.

The above-mentioned conductive particle is used in an anisotropic conductive adhesive. That is, the conductive particle according to the present invention is dispersed in an insulating adhesive so as to produce the anisotropic conductive adhesive. Accordingly, the anisotropic conductive adhesive provides the above-mentioned advantages of the conductive particle according to the present invention.

The anisotropic conductive adhesive according to the present invention may be formed as a film material, and a relationship between a diameter D of the conductive particle and a thickness T of the film material may be represented by D≧T.

Additionally, an average diameter of the conductive particles may be within a range from 2 μm to 30 μm, and a CV value of the conductive particles may be less than 20%.

Further, the anisotropic conductive adhesive may be used for bonding a terminal electrode of a liquid crystal display element using a resin board to a terminal electrode of a flexible wiring board by thermo-compression bonding, and a degree of compression deformation of the conductive particles when the thermo-compression bonding is performed may be within a range from 20% to 80%.

The above-mentioned anisotropic conductive adhesive according to the present invention is used for manufacturing a liquid crystal display device. That is, the anisotropic conductive adhesive according to the present invention is used for bonding terminal electrodes of a liquid crystal display element using a resin board to terminal electrodes of a flexible wiring board by performing thermo-compression bonding.

Additionally, there is provided according to another aspect of the present invention a conductive particle for an anisotropic conductive adhesive, comprising:

a particle body; and

an irregularity formed on a surface of the particle body,

wherein the conductive particle is provided in an insulating adhesive so as to produce the anisotropic conductive adhesive used for conductively bonding a plurality of conductive members; and

a degree of the irregularity formed on the surface of the particle body is sufficient for eliminating the insulating adhesive between the conductive particle and each of the conductive members so that the conductive particle contacts each of the conductive members when the anisotropic conductive adhesive is subjected to a predetermined pressure during a curing process of the anisotropic conductive adhesive.

According to this invention, the irregularity of the surface of the conductive particle functions to remove the insulating adhesive existing between the conductive particle and the conductive members when a pressure is applied to the anisotropic conductive adhesive including the conductive particle. Accordingly, a good and reliable conductivity between the conductive members bonded by the anisotropic conductive adhesive can be obtained.

In the above-mentioned conductive particle, the irregularity may have a depth ranging from 0.05 μm to 2 μm, and a density of peaks of the irregularity may be 1,000 peaks/mm² to 500,000 peaks/mm².

Additionally, the particle body may comprises:

a particle core; and

a conductive layer formed on the particle core,

wherein the irregularity is defined by a surface roughness of the conductive layer.

Further, the conductive particle may show a characteristic of a hard elastic sphere until a compression force reaches 2 gf/particle to 3 gf/particle at an ordinary temperature, and the conductive particle may crush and begin to plastically deform when the compression force reaches 2 gf/particle to 3 gf/particle.

The conductive particle according to the above-mentioned invention is also used in an anisotropic conductive adhesive. Additionally, such an anisotropic conductive adhesive is used for bonding terminal electrodes of a liquid crystal display element using a resin board to terminal electrodes of a flexible wiring board by performing thermo-compression bonding.

Additionally, there is provided according to another aspect of the present invention an anisotropic conductive adhesive comprising:

an insulating adhesive; and

conductive particles dispersed in the insulating adhesive at a dispersion density ranging from 300 pieces/mm² to 650 pieces/mm².

In the above-mentioned invention, the range of the dispersion density is determined so as to prevent a short circuit between adjacent conductive members, such that they are insulated from each other, and to maintain a good conductivity between conductive members to be bonded. That is, when the dispersion density of the conductive particles is greater than 300 pieces/mm² and less than 650 pieces/mm², a good insulation can be provided between the adjacent conductive members while maintaining a good conductivity between opposed conductive members to be conductively bonded.

In the above-mentioned invention, an average diameter of the conductive particles may be within a range from 2 μm to 30 μm.

The above-mentioned anisotropic conductive adhesive can be used for bonding terminal electrodes of a liquid crystal display element using a resin board to terminal electrodes of a flexible wiring board by performing thermo-compression bonding.

Accordingly, there is provided according to another aspect of the present invention a liquid crystal display device comprising:

a liquid crystal display element having terminal electrodes for external connection, the liquid crystal display element using a resin board;

a flexible wiring board having terminal electrodes bonded to the terminal electrodes of the liquid crystal display element; and

an anisotropic conductive adhesive for bonding the terminal electrodes of the flexible wiring board to the terminal electrodes of the liquid crystal display element,

wherein the anisotropic conductive adhesive comprises:

an insulating adhesive; and

conductive particles dispersed in the insulating adhesive at a dispersion density ranging from 300 pieces/mm² to 650 pieces/mm².

In the above-mentioned liquid crystal display device, pitches of the terminal electrodes of the liquid crystal display device may be within a range from 150 μm to 400 μm.

Additionally, there is provided according another aspect of the present invention a method for manufacturing a liquid crystal display device, comprising the steps of:

preparing an anisotropic conductive adhesive comprising an insulating adhesive and conductive particles dispersed in the insulating adhesive at a dispersion density ranging from 320 pieces/mm² to 600 pieces/mm², the conductive particles having an average diameter of 20 μm; and

bonding terminal electrodes of a liquid crystal display element using a resin board to terminal electrodes of a flexible wiring board by using the anisotropic conductive adhesive an performing thermo-compression bonding.

The terminal electrodes of the liquid crystal display element may preferably be arranged with pitches ranging from 150 μm to 400 μm.

Additionally, a thickness of the terminal electrodes of the flexible wiring board may preferably be 18 μm, and a thickness of the anisotropic conductive adhesive may preferably be 16±3 μm measured before the thermo-compression bonding is performed.

Other objects, features and advantages of the present invention will become more apparent from the following detailed description when read in conjunction with the accompanying drawings.

### BRIEF DESCRIPTION OF THE DRAWINGS

FIG. 1 is an illustration of a conductive particle according to a first embodiment of the present invention;

FIG. 2 is a graph showing a compressive deformation characteristic of the conductive particle shown in FIG. 1;

FIG. 3A is an illustration of a state of the conductive particle before a compression force F is applied thereto; FIG. 3B is an illustration of a state of the conductive particle when a compression force F is applied thereto;

FIG. 4 is an illustration of a conductive particle including a gold layer;

FIG. 5 is an illustration of an anisotropic conductive adhesive according to the first embodiment of the present invention;

FIGS. 6A and 6B are illustrations for explaining a process for bonding wiring patterns formed on two wiring boards by using the anisotropic conductive adhesive;

FIG. 7 is an illustration for showing a state of the conductive particle crushed by a pressure;

FIG. 8 is a plan view of a liquid crystal display device using a polymer film as a base board;

FIG. 9 is a cross-sectional view of the liquid crystal display device taken along a line IX-IX of FIG. 8;

FIG. 10 is a plan view of a liquid crystal display device of a one-side electrode connection type;

FIG. 11 is a cross-sectional view of the liquid crystal display device taken along a line XI-XI of FIG. 10;

FIGS. 12A, 12B and 12C are illustrations for explaining a method for bonding terminal electrodes of a liquid crystal display device to terminal electrodes of a flexible wiring board of a drive circuit device by using the anisotropic conductive adhesive according to the present invention;

FIG. 13A is a plan view of a part shown in FIG. 12A; FIG. 13B is a plan view of a part shown in FIG. 12B

FIG. 14A is an illustration for showing a state of a conductive particle having a compression deformation characteristic C1 shown in FIG. 2 being used for bonding a terminal electrode of a drive circuit board to a terminal electrode of a liquid crystal display element; FIG. 14B is an illustration for showing a state of a conductive particle having a compression deformation characteristic C2 shown in FIG. 2 being used for bonding a terminal electrode of a drive circuit board to a terminal electrode of a liquid crystal display element; FIG. 14C is an illustration for showing a state of a conductive particle having a compression deformation characteristic C3 shown in FIG. 2 being used for bonding a terminal electrode of a drive circuit board to a terminal electrode of a liquid crystal display element;

FIG. 15 is an illustration for showing a diameter of the conductive particle and a thickness of an insulating adhesive included in the anisotropic conductive adhesive according to the present invention;

FIGS. 16A and 16B are illustrations of a conductive particle according to a second embodiment of the present invention;

FIG. 17 is a variation of the conductive particle shown in FIG. 16B;

FIGS. 18A and 18B are photographs of the conductive particle according to the second embodiment of the present invention; and

FIGS. 19A and 19B are photographs of a conductive particle produced by a conventional method.

### DETAILED DESCRIPTION OF THE PREFERRED EMBODIMENTS

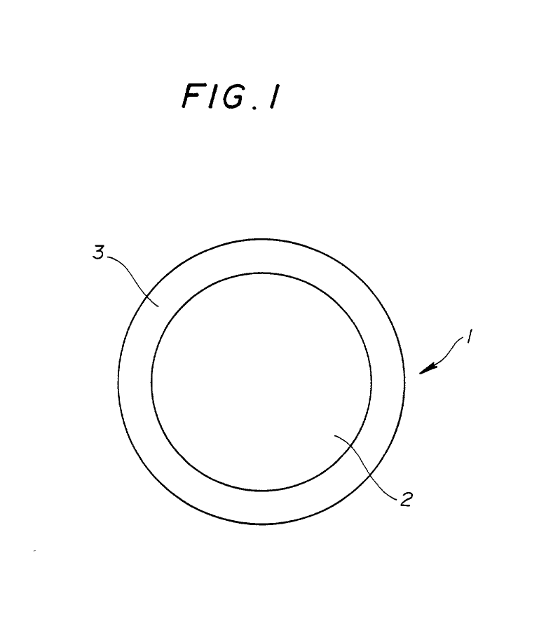

A description will now be given of a first embodiment of the present invention. FIG. 1 is an illustration of a conductive particle 1 according to the first embodiment of the present invention. As shown in FIG. 1, the conductive particle 1 comprises a core particle 2 and a conductive layer 3 formed on a surface of the core particle 2.

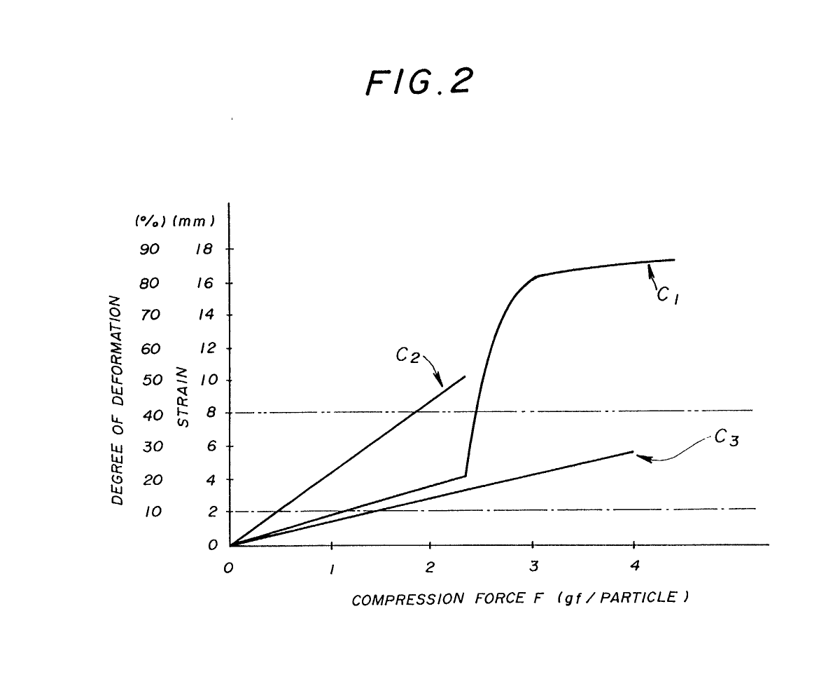

The conductive particle 1 according to the present embodiment has a feature in a compressive deformation characteristic when a compression force is applied thereto. FIG. 2 is a graph showing the compressive deformation characteristic of the conductive particle 1. A line indicated by C1 represents the conductive deformation characteristic of the conductive particle 1. Additionally, conductive deformation characteristics C2 and C3 of conventional conductive particles are shown in FIG. 2 for the purpose of comparison. It should be noted that the compressive deformation characteristics C1, C2 and C3 in the graph of FIG. 2 were obtained by measuring a compression strain S (mm) (or a degree of deformation (%)) by applying a compression force F to the particle at an ordinary temperature (a room temperature of 23° C.).

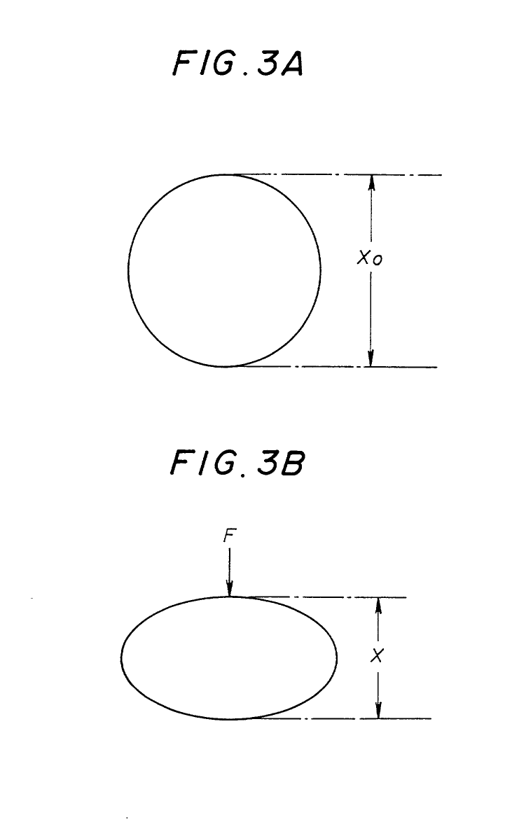

FIG. 3A shows a state of the conductive particle before a compression force F is applied thereto; FIG. 3B shows a state of the conductive particle when a compression force F is applied thereto. As shown in FIG. 3A, the conductive particle has a diameter X0 (mm) before the compression force F is applied. When the compression force F is applied to the conductive particle, the diameter X0 of the conductive particle becomes X (mm) as shown in FIG. 3B. At this time, the strain S (mm) of the conductive particle is obtained as S=(X0−X). Additionally, a degree of deformation (%) is obtained by (X0−X)/X0. It should be noted that conductive particles having a diameter of about 20 μm were used to obtain the compressive deformation characteristics shown in FIG. 2.

Referring to FIG. 2, the conventional conductive particle having the compressive deformation characteristic C2 elastically deforms as the compression force F increases. The rate of deformation of the conventional conductive particle having the compressive deformation characteristic C2 is relatively large, that is, a modulus of compressive deformation is relatively small. This means that the conventional conductive particle having the compressive deformation characteristic C2 has a characteristic of a soft elastic sphere.

Additionally, the conventional conductive particle having the compressive deformation characteristic C3 elastically deforms as the compression force F increases. The rate of deformation of the conventional conductive particle having the compressive deformation characteristic C3 is relatively small, that is, a modulus of compressive deformation is relatively large. This means that the conventional conductive particle having the compressive deformation characteristic C3 has a characteristic of a hard elastic sphere.

The conductive particle 1 having the compressive deformation characteristic C1 shows an elastic characteristic the same as that of the conventional conductive particle having the compressive deformation characteristic C3 in the initial stage of application of the compression force F. That is, the conductive particle 1 has the characteristic of a hard elastic sphere until the compression force F reaches 2 gf/particle to 3 gf/particle. However, the conductive particle 1 starts to crush when the compression force F reached 2 gf/particle to 3 gf/particle. The term “crush” means a state of the conductive particle 1 in which the conductive particle 1 is plastically deformed by a pressure and a permanent deformation (strain) remains when the pressure is released.

In other words, the conductive particle 1 having the compressive deformation characteristic shown in FIG. 2 has a yield point or inflection point within a range of a degree of deformation from 5% to 40%. Beyond the yield point, a degree of deformation of the conductive particle 1 is drastically increased by less increase in the compression force F.

A value of K can be used as an index for evaluating a compressive deformation of a conductive particle, that is, as an index of evaluation of hardness. The conductive particle 1 according to the present invention has a value of K ranging from 10 to 100 kgf/mm² when the degree of deformation is 40%. K is represented by the following equation (1) where F is a compression force (kgf), S is a compression strain (mm), and R is a diameter (mm) of a particle.

K=(3/2^{½})·(S^{-3/2})·(R^{-½})·F (1)

It should be noted that the above equation (1) is obtained by the following procedure. That is, in general, a relationship between a compression force and a deformation (strain) can be obtained approximately by the following equation (2) by modifying the Schultz formula, where E is a modulus of compression elasticity (kgf/mm²) and a is a Poisson ratio.

F=(2^{½}/3)·(S^{3/2})·(R^{½})·(E)/(1−σ²) (2)

If K is defined as K=(E)/(1−σ²), the equation (1) is obtained. A value of K can be obtained by entering measured values of F, S and R in the equation (1).

In this case, since a value of K of the conductive particle 1 is 10 to 100 (kgf/mm²) when a degree of deformation is 40%, the conductive particle 1 shows a characteristic as a hard elastic sphere at the stage of an initial compression force. However, the when the compression force F is increased and exceeds a certain value, the conductive particle 1 rapidly crushes and is plastically deformed. That is, the conductive particle 1 has an yield point or an inflection point within a range of degree of deformation from 5% to 40% at which yield point the degree of deformation drastically increases.

The above-mentioned compressive deformation characteristic of the conductive particle 1 can be provided by the core particle 2. In such a case, the core particle 2 may be formed by either an inorganic material or an organic material. Additionally, the core particle 2 may be either a solid particle or a hollow particle. Further, the core particle 2 may be an agglomerate of fine particles having a diameter corresponding to ⅓ to 1/100 of an average diameter of the core particle 2.

Specifically, the core particle 2 can be formed of an inorganic material such as a hollow glass particle, a hollow silica particle, a hollow shirasu particle, a hollow ceramic particle or a silica agglomerate may be used. Since the inorganic material is relatively hard, it is preferable for the conductive particle 1 according to the present invention to use a polymer particle (for example, a particle made of plastic) to form the core particle 2.

A resin material for forming the core particle 2 may be selected from a (meta)acrylate resin, a polystyrene resin, a styrene-(meta)acrylate copolymer resin, a urethane resin, an epoxy resin and a polyester resin.

When the core particle 2 is made of a (meta)acrylate resin, the (meta)acrylate resin preferably is a copolymer of (meta)acrylate ester and a composite having a reactive double bond which is copolymerizable with the (meta)acrylate ester, if necessary, and a bifunctional or multifunctional monomer.

Additionally, when the core particle 2 is made of a polystyrene resin, the polystyrene resin preferably be a copolymer of a derivative of styrene and a composite having a reactive double bond which is copolymerizable with the derivative, if necessary, and a bifunctional or multifunctional monomer.

However, since a regular (meta)acrylate resin and a regular polystyrene resin have a high compression braking strength when they are formed in a high bridge density, the conductive particle cannot crush at a pressure applied thereto during a thermo-compression bonding. Additionally, when they are unbridged or formed in a low bridge density, the conductive particle 1 crushes at a compression force lower than 2 gf/particle. Accordingly, in the present invention, those resins are formed to have an appropriate bridge structure having an appropriate bridge density so as to render a compression braking strength to fall within the above-mentioned range, that is, to have the conductive particle 1 crush when the compression force reaches at a value within a range from 2 gf/particle to 3 gf/particle.

When the core particle 2 is made of a (meta)acrylate resin, a (co)polymer of (meta)acrylate ester is preferable. Further, a copolymer of a (meta)acrylate ester monomer and other monomers can be used.

As for the (meta)acrylate ester monomer, methyl (meta)acrylate, ethyl (meta)acrylate, propyl (meta)acrylate, butyl (meta)acrylate, 2-ethylhexyl (meta)acrylate, lauryl (meta)acrylate, stearyl (meta)acrylate, cyclohexyl (meta)acrylate, 2-hydroxyethyl (meta)acrylate, 2-propyl (meta)acrylate, chloro-2-hydroxyethyl (meta)acrylate, diethylene glycol mono(meta)acrylate, methoxyethyl (meta)acrylate, glycidyl (meta)acrylate, dicyclopentanyl (meta)acrylate, dicyclopentenyl (meta)acrylate and isoboronol (meta)acrylate may be used.

As for the styrene monomer, there are an alkyl styrene such as styrene, methylstyrene, dimethylstyrene, trimethylstyrene, ethylstyrene, diethylstyrene, triethylstyrene, propylstyrene, butylstyrene, hexylstyrene, heptylstyrene or octylstyrene; a styrene halide such as phlorostyren, chlorostyrene, bromostyrene, dibromostyrene, iodostyrene or chloromethylstyrene; nitrostyrene; acetylstyrene and methoxystyrene.

The core particle 2 is preferably made of a single resin such as (meta)acrylate resin or a styrene resin. However, the core particle may be made of a composition of those resins. Additionally, a copolymer of a (meta)acrylate ester monomer and a styrene monomer may be used.

Additionally, as for the (meta)acrylate resin or the styrene resin, a copolymer of a (meta)acrylate ester monomer and/or a styrene monomer and, if necessary, other copolymerizable monomers may be used.

As for other monomers copolymerizable with the (meta)acrylate ester monomer or a styrene monomer, there are vinyl monomer and unsaturated carboxylic monomer.

As for the vinyl monomer, there are vinyl pylidine, vinyl pyrrolidone, vinyl carbazol, vinyl acetate, acrylonitril; a conjugate diene monomer such as butadiene, isoprene and chloroprene; a vinyl halide such as vinyl chloride and vinyl bromide; and a vinyliden halide such as vinyliden chloride.

As for the unsaturated carboxilic monomer, there are addition copolymerization unsaturated aliphatic monocarboxilate acids such as acrylic acid, (meta)acrylate, α-ethyl (meta)acrylate, crotonic acid, α-methylcrotonate, α-ethylcrotonate, isocrotonic acid, tiglic acid and ungerica acid. Additionally, there are addition copolymerization unsaturated fatty acid group dicarboxilate acids such as maleic acid, fumaric acid, itaconic aicd, citraconic acid, mesaconic acid, glutaconic acid and hydromconic acid.

In order to form a bridge structure in the resin of the core particle, a bifunctional or multifunctional monomer may be used. As for the bifunctional or multifunctional monomer, there are ethyleneglycol di(meta)acrylate, triethyleneglyciol di(meta)acrylate, tetraethyleneglycol di(meta)acrylate, trimethylolpropane tri(meta)acryulate, pentaethlytol tri(meta)acrylate, trishydroxymethylethane diacrylate, trishydroxymethylethane triacrylate, trishydroxymethylpropane triacrylate and divinyl benzene.

Especially, in the present invention, as for a difunctional or multifunctional monomer, vinyl benzene is preferably used. When the core particle 2 is made of a (meta)acrylate resin, a copolymer comprising the following components can be used: 20 to 100 weight percentage (preferably 40 to 100 weight percentage) of a (meta)acrylate ester monomer; 0 to less than 20 weight percentage (preferably 0 to 15 weight percentage) of a styrene monomer; 0 to 50 weight percentage of a vinyl monomer; and 0 to 50 weight percentage of an unsaturated carboxylic acid monomer.

Additionally, when the core particle 2 is made of a styrene resin, a copolymer comprising the following components can be used: 20 to 100 weight percentage (preferably 40 to 100 weight percentage) of a styrene monomer; 0 to less than 20 weight percentage (preferably 0 to 15 weight percentage) of a (meta)acrylate monomer; 0 to 50 weight percentage of a vinyl monomer; and 0 to 50 weight percentage of an unsaturated carboxylic acid monomer.

Additionally, when the core particle 2 is made of a copolymer of a (meta)acrylate ester monomer and a styrene monomer, a copolymer comprising the following components can be used: 20 to 80 weight percentage (preferably 40 to 60 weight percentage) of a (meta)acrylate ester monomer; 20 to 80 weight percentage (preferably 40 to 60 weight percentage) of a styrene monomer; 0 to 50 weight percentage of a vinyl monomer; and 0 to 50 weight percentage of an unsaturated carboxylic acid monomer.

In order to form a bridge structure in the resin particle, a bifunctional or multifunctional monomer is preferably used. Additionally, in order to achieve the compression braking strength according to the present invention, that is, in order to obtain the conductive particle which crushes when a compression force reaches 2 gf/particle to 3 gf/particle, the amount of bifunctional or multifunctional monomer is adjusted to obtain an appropriate bridge structure. Specifically, the amount of the bifunctional or multifunctional monomer is adjusted to 0.1 to 50 weight percentage, preferably 1 to 20 weight percentage.

The above-mentioned examples are for producing a single particle which has a compression braking strength falling within a range defined by the present invention. However, the present invention is not limited to use of such a bifunctional or multifunctional monomer, and other methods can be used. For example, an agglomerate particle having an average diameter of 2 to 30 μm can be used. Such an agglomerate particle can be formed by resin particles each of which has a diameter which is ⅓ to 1/100 of a diameter of the core particle. In the thus-formed agglomerate particle, the resin particles are connected to each other by a relatively low bonding force, and a compression braking force of less than 4 kgf/mm², preferably less than 3 kgf/mm², can be used for the conductive particle 1 according to the present invention.

Additionally, the conductive particle 1 according to the present invention can be a hollow resin particle. A compression braking strength of the hollow resin particle can be reduced by reducing a thickness of a resin layer. In order to achieve the conductive particle 1 according to the present invention, a compression braking strength can be adjusted to less than 4 kgf/mm², preferably less than 3 kgf/Mm². Additionally, instead of adjusting the thickness of the resin layer, a compression braking strength can be adjusted by copolymerizing bifunctional or multifunctional monomers as mentioned above.

As mentioned above, the core particle 2 of the conductive particle 1 according to the present invention can be made of an arbitrary material as long as the conductive particle 1 has a yield point or an inflection point for a compression force within a range of compressive deformation from 5% to 40%, a compression strain or deformation starting to drastically increase at the yield point. In other words, the core particle 2 of the conductive particle 1 according to the present invention can be made of an arbitrary material as long as the conductive particle 1 shows a characteristic of a hard elastic sphere until a compression force reaches 2 gf/particle to 3 gf/particle at an ordinary temperature, and the conductive particle crushes and begins to plastically deform when the compression force reaches 2 gf/particle to 3 gf/particle.

The conductive particle 1 according to the present invention has the above-mentioned compressive deformation characteristic. Accordingly, when an anisotropic conductive adhesive containing the conductive particle 1 is used for conductively bonding electrodes, the electrodes or a base board is not deformed or damaged.

In the conductive particle 1, the conductive layer 3 is formed on the core particle 2. The conductive layer 3 can be formed by a conductive metal, an alloy containing such a conductive metal, a conductive ceramic, a conductive metal oxide or other conductive materials.

As for the conductive metal, there are Zn, Al, Sb, U, Cd, Ga, Ca, Au, Ag, Co, Sn, Se, Fe, Cu, Th, Pb, Ni, Pd, Be and Mg. Those metals can be used alone or more than two of them can be used. Additionally, other elements or compounds such as a solder may be added. As for the conductive ceramic, there are VO₂, Ru₂O, SiC, ZrO₂, Ta₂N, ZrN, NbN, VN, TiB₂, ZrB, HfB₂, MoB₂, CrB₂, B₄C, MoB, ZrC, VC and TiC. Additionally, as for the conductive material other than the above-mentioned materials, there are a carbon particle such as carbon and graphite and ITO.

It is particularly preferable to add gold to the conductive layer 3 from among the above-listed conductive metals. By adding gold to the conductive layer 3, an electric resistance of the conductive layer 3 is reduced and a spreadability is improved which results in a good conductivity. Additionally, when such an anisotropic conductive adhesive (in the form of an anisotropic film) containing the conductive particle including gold is used to bond electrodes formed on circuit boards, the electrodes are not damaged since gold has a low hardness.

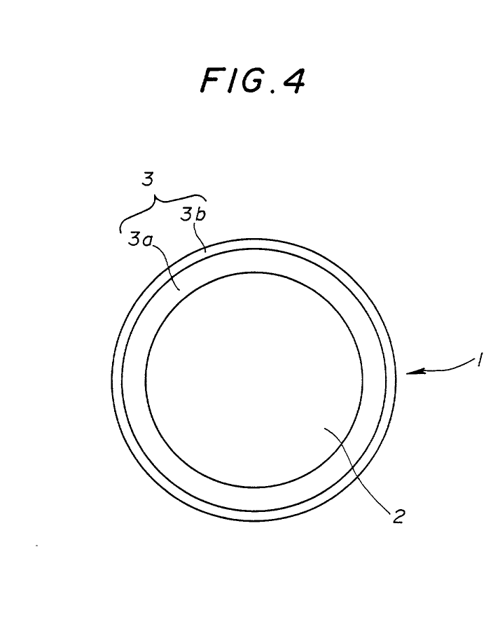

Specifically, as shown in FIG. 4, the conductive layer 3 preferably comprises a nickel (Ni) layer 3a and a gold (Au) layer 3b formed on a surface of the nickel layer 3a. The gold layer 3a may be formed by replacing a surface layer of the nickel layer 3a.

The conductive layer 3 can be formed by various methods such as a physical deposition method, a chemical deposition method or an adsorption method. The physical deposition method includes a vapor deposition method, an ion sputtering method, an electroless plating method and a thermal spraying method. In the chemical deposition method, a conductive material is chemically bonded to a surface of a core particle made of a resin having a functional group. In the adsorption method, a conductive material is adsorbed by a surface of a core particle by using a surfactant. Additionally, another method may be used in which a core particle and a conductive layer are simultaneously formed by depositing a conductive material on a surface of the core particle by providing the conductive material in a reactive system for forming the core particle. Especially, the electroless plating method is preferable to form the conductive layer 3 according to the present invention. When the electroless plating method is used, an oxidation and reducing reaction during an electroless plating process may be promoted by increasing a concentration of palladium in a pretreatment process of the electroless plating process. It should be noted that the conductive layer 3 is not necessarily formed in a single layer, and a plurality of layers may be formed on the core particle 2.

A thickness of the conductive layer 3 is normally set within a range from 0.01 μm to 10.0 μm, and preferably is from 0.05 μm to 5 μm, and most preferably is from 0.2 μm to 2 μm. It should be noted that an insulating layer may be formed on the conductive layer 3. As for the method for forming the insulating layer, there is a method in which a noncontinuous insulating layer comprising polyvinylidene fluoride is formed by a hybridization system. In this method, 2 to 8 weight percentage of polyvinylidene fluoride is used for 100 weight percentage of conductive particle. The conductive layer is processed for 5 to 10 minutes at a temperature of 85 to 115° C. The thus-formed insulating layer normally ranges from 0.1 μm to 0.5 μm. It should be noted that the insulating layer may incompletely cover the entire surface of the conductive particle.

As mentioned above, the conductive particle 1 of the present invention has the above-mentioned compressive deformation characteristic, and thereby when an anisotropic conductive adhesive (in the form of an anisotropic film) containing the conductive particle 1 is used to bond electrodes formed on circuit boards, the electrodes or the circuit board are not deformed or damaged.

It should be noted that when the conductive particle 1 according to the present invention is used in an anisotropic conductive adhesive (anisotropic conductive film) as described later, an average diameter of the conductive particle 1 may be 2 μm to 50 μm, preferably 5 μm to 30 μm.

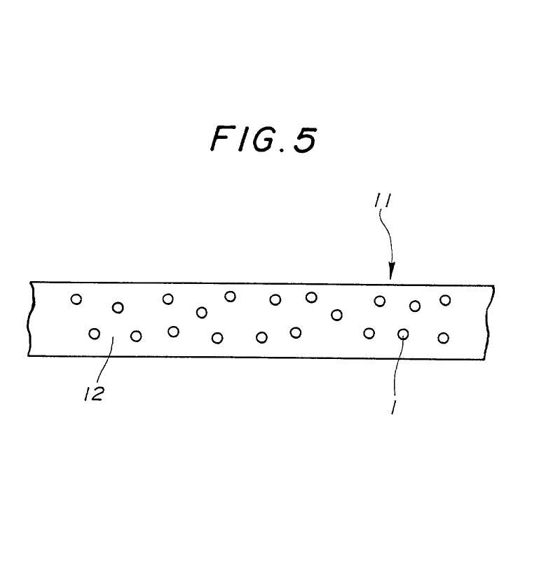

FIG. 5 is an illustration of an anisotropic conductive adhesive 11 according to the first embodiment of the present invention. It should be noted that the anisotropic conductive adhesive 11 shown in FIG. 5 is provided in the form of an anisotropic conductive film. The anisotropic conductive adhesive 11 comprises an insulating adhesive 12 and the conductive particles 1 dispersed in the insulating adhesive according to a predetermined mixing ratio.

Specifically, the conductive particles 1 are dispersed in the insulating adhesive 12 to a predetermined density so that the anisotropic conductive adhesive 11 can provide a function of an appropriate anisotropic conductive adhesive. That is, the conductive particles 1 are dispersed in the insulating adhesive 12 so that when the anisotropic conductive adhesive 11 is used to bond two wiring boards, the conductive particles 11 can provide a function to conductively bond wiring patterns formed on the wiring boards while insulating the electrodes on the same wiring board. More specifically, the conductive particles 1 are dispersed in the insulating adhesive 12 to 50 to 5,000 pieces/mm², preferably 100 to 3,000 pieces/mm², most preferably 300 to 1,000 pieces/mm².

Additionally, each of the conductive particles 1 contained in the anisotropic conductive adhesive 11 comprises the conductive layer 3 formed on the core particle 2, wherein the conductive particle 1 has a yield point or inflection point within a range of degree of deformation from 5% to 40%, a modulus of compressive deformation of the conductive particle drastically increasing at the yield point or inflection point. That is, each of the conductive particles 1 shows a characteristic of a hard elastic sphere until a compression force reaches 2 gf/particle to 3 gf/particle at an ordinary temperature, and crushes and begins to plastically deform when the compression force reaches 2 gf/particle to 3 gf/particle.

More specifically, the core particle 2 of each of the conductive particles 1 is formed of a predetermined resin material, and the conductive layer 3 is formed by coating a predetermined metal on an entire surface of the core particle 2, such that each of the conductive particles 1 shows a characteristic of a hard elastic sphere until a compression force reaches 2 gf/particle to 3 gf/particle at an ordinary temperature, and each of the conductive particles 1 crushes and begins to plastically deform when the compression force reaches 2 gf/particle to 3 gf/particle.

In each of the conductive particles 1, when a compressive elastic deformation characteristic K of said conductive particle is represented as K=(3/2^{½})·(S^{-3/2})·(R^{-½})·F, a value of K is 10 to 100 (kgf/mm²) when a degree of compressive deformation of each of the conductive particles 1 is 40%, where F is a compression force (kgf), S is a compression strain (mm) and R is a radius (mm) of each of the conductive particles.

Each of the conductive particles 1 is positively crushed when the anisotropic conductive adhesive 11 is used for bonding electrodes. That is, the core particle 2 forming the conductive particle 1 is positively crushed by a pressure of 10 kg/cm² to 30 kg/cm² at a temperature of 120° C. to 170° C. for 1 second to 10 seconds, and the thus-deformed conductive particle 1 does not return to an original form when the pressure is released.

The conductive particles 1 have an average diameter of 2 μm to 50 μm, preferably 5 μm to 30 μm. Additionally, a CV value of each of the conductive particles 1 is preferably less than 20%. The CV value is a ratio (σ/AV) of a standard deviation σ of diameters of the conductive particles 1 to an average diameter AV of the conductive particles 1 contained (dispersed) in the anisotropic conductive adhesive 11. The CV value preferably is as small as possible. That is, the conductive particles 1 contained in the anisotropic conductive adhesive 11 preferably have the same diameter as much as possible.

Additionally, as for the insulating adhesive 12 of the anisotropic adhesive 11 shown in FIG. 5, a (meta)acrylate-base adhesive, an epoxy-base adhesive, a polyester-base adhesive, an urethane-base adhesive or a rubber-base adhesive can be used. Especially, in the present invention, a (meta)acrylate base adhesive is preferable.

As for the acrylic adhesive, a copolymer of (meta)acrylate ester and a compound having a reactive double bond copolymerizable with the (meta)acrylate ester can be used. As for the (meta)acrylate ester, there are methyl (meta)acrylate, ethyl (meta)acrylate, isopropyl (meta)acrylate, butyl (meta)acrylate, 2-ethylhexyl (meta)acrylate, lauryl (meta)acrylate, stearyl (meta)acrylate, cyclohexyl (meta)acrylate, 2-hydroxyethyl (meta)acrylate, 2-hydroxypropyl (meta)acrylate, chloro-2-hydroxypropyl (meta)acrylate, dimethyleneglycol mono(meta)acrylate, methoxymethyl (meta)acrylate, ethoxyethyl (meta)acrylate, dimethylaminoethyl (meta)acrylate and glicidyl (meta)acrylate.

As for the compound having an active double bond copolymerizable with the (meta)acrylate ester, there are an unsaturate carboxilic acid monomer, a styrene-base monomer and a vinyl-base monomer.

As for the unsaturates carboxilic monomer, there is addition copolymerization unsaturates fatty acid group monocarboxilate acids such as acrylic acid, (meta)acrylate, α-ethyl (meta)acrylate, crotonic acid, α-methylcrotonate, α-ethylcrotonate, isocrotonic acid, tiglic acid and ungerica acid. Additionally, there is addition copolymerization unsaturated aliphatic acid dicarboxilate acids such as maleic acid, fumaric acid, itaconic acid, citraconic acid, mesaconic acid, glutaconic acid and hydromconic acid.

As for the styrene-base monomer, there are an alkyl styrene such as styrene, methylstyrene, dimethylstyrene, trimethylstyrene, ethylstyrene, diethylstyrene, triethylstyrene, propylstyrene, butylstyrene, hexylstyrene, heptylstyrene or octylstyrene; a styrene halide such as phlorostyren, chlorostyrene, bromostyrene, dibromostyrene or iodostyrene; nitrostyrene; acetylstyrene and methoxystyrene.

As for the vinyl-base monomer, there are vinyl pylidine, vinyl pyrrolidone, vinyl carbazol, vinyl benzene, vinyl acetate, acrylonitril; conjugate diene monomers such as butadiene, isoprene and chloroprene; vinyl halides such as vinyl chloride and vinyl bromide; and a vinyliden halide such as vinyliden chloride.

The (meta)acrylic adhesive can be produced by copolymerizing 60 to 90 weight percentage of the above-mentioned (meta)acrylate ester and 10 to 40 weight percentage of other monomers.

The acrylic adhesive can be produced by an ordinary method. For example, the acrylic adhesive can be produced by dissolving or dispersing the above-mentioned monomer in an organic solvent and processing the solvent within a reaction chamber filled by an inert gas. As for the organic solvent, there are an aromatic hydrocarbon such as toluene or xylene; an aliphatic hydrocarbon such as n-hexane; an ester such as ethyl acetate or butyl acetate; an aliphatic alcohol such as n-propylalcohol or i-propylalcohol; and a ketone such as methylethylketone, methylisobutylketon or cyclohexanone. In the above-mentioned reaction process, normally 100 to 250 weight percentage of organic solvent is used with respect to 100 weight percentage of a (meta)acrylic resin adhesive raw material.

The reaction process is performed by applying heat under existence of a polymerization initiator. As for such a polymerization initiator, there are azobis isobutyronitrile, benzoyl peroxide, di-tertbytylperoxide, and cumenyl hydroperoxide. The polymerization initiator is used by 0.01 to 5 weight percentage with respect to 100 weight percentage of a raw material monomer.

The polymerization in the organic solvent is performed by heating the reaction solution at 60° C. to 75° C. for normally 2 to 10 hours, preferably 4 to 8 hours. The thus-produced (meta)acrylic resin adhesive has a weight average molecular weight falling within a range from 0.1 million to 1 million.

Such an acrylic adhesive may contain a thermoplastics resin such as an alkylphenol resin, a terpenphenol resin, a denaturated rosin resin or a xylene resin. Additionally, a reaction curing resin such as an epoxy resin may be added. Further an imidazole compound of such a reaction curing resin may be added.

The anisotropic conductive adhesive 11 can provide an isotropic conductive bonding by the conductive particles 1 being dispersed in the insulating adhesive 12 to 50 pieces/mm² to 5,000 pieces/mm², preferably 100 pieces/mm² to 300 pieces/mm², most preferably 300 pieces/mm² to 1,000 pieces/mm².

Additionally, it is preferable to add a filler to the insulating resin 12. As for the filler, an insulating inorganic particle such as titanium oxide, silicon dioxide, calcium carbonate, calcium phosphate, aluminum oxide or antimony oxide is preferable. The insulating organic particle normally has an average diameter of 0.01 μm to 5 μm. The above-mentioned insulating organic particle can be used alone or as a combination. The insulating organic particle is used normally at 10 to 100 weight percentage, preferably 50 to 80 weight percentage, with respect to 100 weight percentage of a resin component of the adhesive.

The flowability of the insulating adhesive 12 can be adjusted by adding the insulating inorganic particle as the filler. Accordingly, the adhesive 12 can be prevented from flowing in a reverse direction even if the adhesive 12 is heated after adhesion. This reduces a possibility of deterioration of conductivity due to reversed insulating adhesive. Additionally, when the anisotropic conductive adhesive 11 is used for bonding wiring patterns of two circuit boards, the insulation adhesive 12 is prevented from bulging out of the circuit boards. As mentioned above, by using silicon resin powder and/or silicon dioxide, reliability with respect to adhesion and conductivity of the anisotropical conductive adhesive can be improved.

When the anisotropic conductive adhesive is formed as an anisotropic conductive film, a thickness of the film preferably is within a range from 10 μm to 50 μm. It should be noted that the anisotropic conductive adhesive 11 can be made in the form of a sheet by using a knife coater, a comma coater, a reverse-roll coater or a gravure coater.

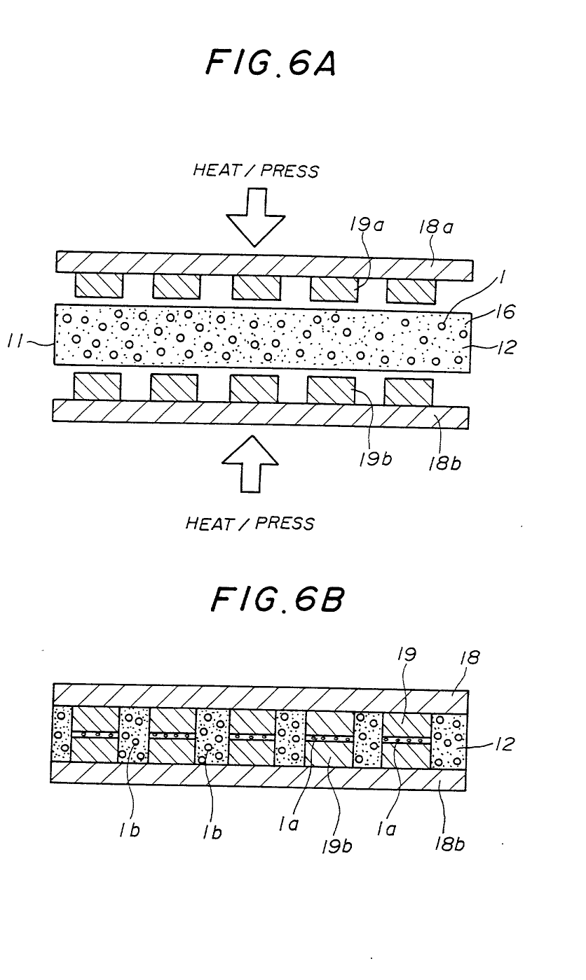

The anisotropic conductive adhesive 11 in the form of a sheet (an anisotropic conductive film) can be used to bond two conductive members as shown in FIGS. 6A and 6B. FIGS. 6A and 6B show a process for bonding wiring patterns 19a and 19b formed on two wiring boards 18a and 18b by using the anisotropic conductive adhesive 1 having the form of a film.

The two wiring boards 18a and 18b are positioned so that the wiring patterns 19a and 19b formed on the respective wiring boards 18a and 18b are opposite to each other. Then, the anisotropic conductive adhesive 11 having the form of a film (anisotropic conductive film) is interposed between the wiring patterns 19a and 19b. It should be noted that the anisotropic conductive film 11 shown in FIGS. 6A and 6B contains the conductive particles 1 dispersed in the insulating adhesive 12 made of an acrylic adhesive, the conductive particles 11 having the above-mentioned compressive deformation characteristic according to the present invention, and fillers 16 are also dispersed in the insulating adhesive 12.

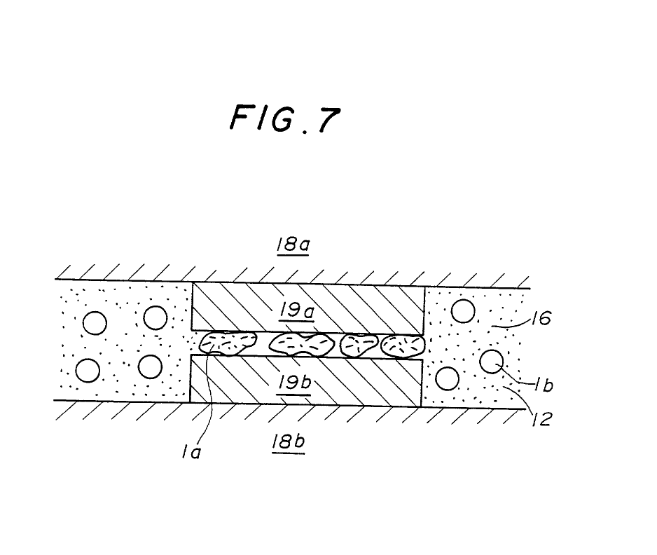

When the wiring boards 18a and 18b are bonded to each other by pressing in a direction indicated by arrows in FIG. 6A at a pressure of 30 to 100 kg/cm² while heating at a temperature from 120° C. to 170° C., the conductive particles 1 positioned between the wiring patterns 19a and 19b receive a largest pressure as shown in FIG. 6B. Accordingly, the conductive particles 1 positioned between the wiring patterns 19a and 19b are crushed. FIG. 7 shows a state of the conductive particles 1 which have been crushed by the pressure. In FIG. 7, the crushed conductive particles 1 are indicated by a reference numeral 1a, and the conductive particles 11 which are not crushed are indicated by a reference numeral 1b.

A pressure applied to wiring boards during a thermo-compression bonding process is normally 30 kg/cm² to 100 kg/cm². However, the conductive particles according to the present invention can be crushed at a pressure from 10 kg/cm² to 30 kg/cm². In FIG. 7, the wiring patterns 19a and 19b are electrically connected by the conductive particles 1 which have been crushed by the pressure applied by the wiring patterns 19a and 19b. On the other hand, the conductive particles 1 positioned out of the space between the wiring patterns 19a and 19b are not subjected to a pressure, and thereby portions of the anisotropic conductive adhesive 11 can provide a good insulating characteristic.

In the above-mentioned example, the anisotropic conductive adhesive 11 has the form of a sheet or a film. However the anisotropic conductive adhesive 11 according to the present invention may have the form of a paste by adding an appropriate solvent to the anisotropic conductive adhesive 11. Such an anisotropic conductive adhesive paste 11 can be applied to a wiring board by using, for example, a screen coater. Accordingly, the anisotropic conductive adhesive 11 according to the present invention may be used in various forms such as a sheet, a film or a paste.

The conductive particles 1 included in the anisotropic conductive adhesive 11 can be crushed by a pressure smaller than a pressure applied during a conventional thermo-compression bonding process since the conductive particles 1 have the characteristic in which a plastic deformation occurs when a compression force is increased to a certain level. Accordingly, when the anisotropic conductive adhesive 11 is used for bonding an electrode formed on a liquid crystal film or an electrode formed on a flexible printed-circuit board, the electrode or the circuit board is not deformed or damaged during the thermo-compression bonding process.

Accordingly, the anisotropic conductive adhesive 11 according to the present invention can be used for bonding wiring patterns formed on two flexible wiring boards, such as resin film boards, by using the anisotropic conductive bonding method, as well as for bonding wiring patterns formed on a glass plate. Especially, the anisotropic conductive adhesive 11 can be preferably used for manufacturing a liquid crystal display device using a polymer film.

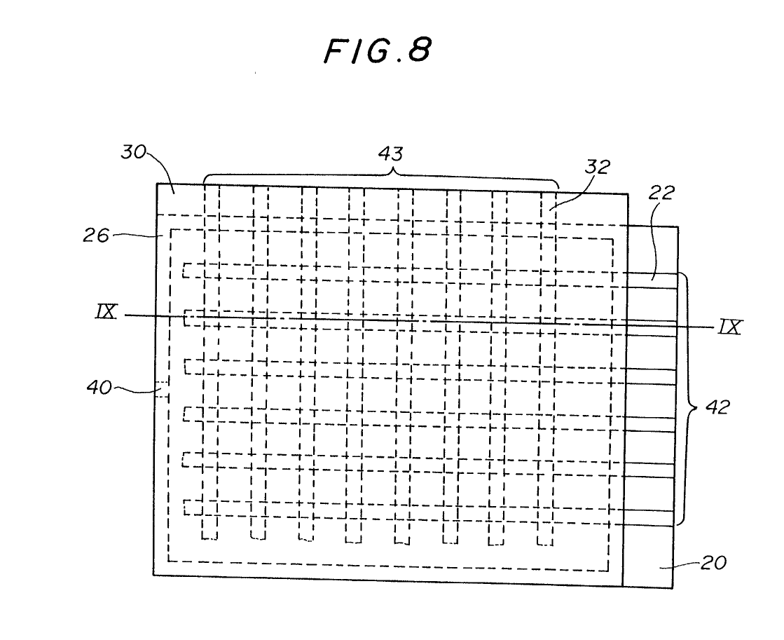

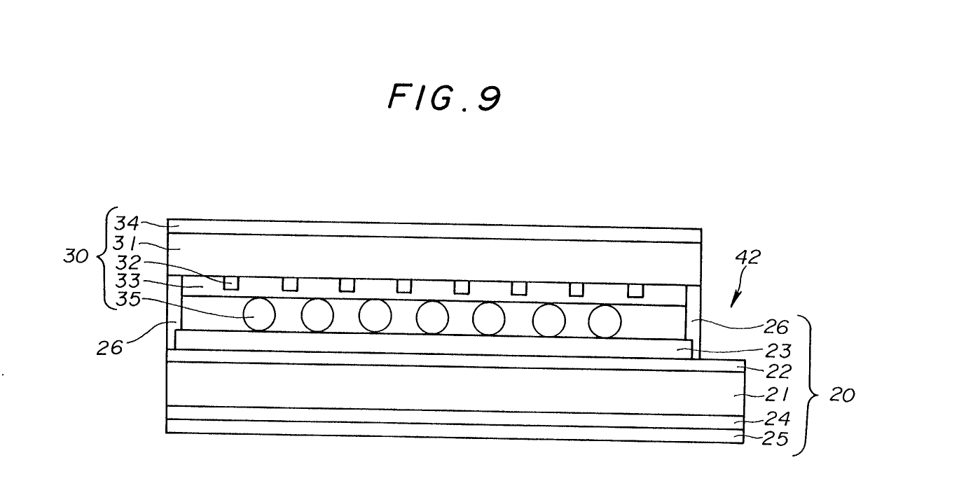

In recent years, such a liquid crystal display device using a polymer film as a base board has attracted considerable attention since such a display device has advantages in that the display device can be made thin and light weight and hardly cracks. FIG. 8 is a plan view of a liquid crystal display device using a polymer film as a base board. FIG. 9 is a cross-sectional view of the liquid crystal display device taken along a line IX-IX of FIG. 8.

Referring to FIGS. 8 and 9, ITO electrodes (wiring pattern) 22 and an orientation film 23 are formed on the front side of a first polymer film board 21. The ITO electrodes 22 are arranged in a stripe pattern having a uniform pitch. A polarization plate 24 and a reflection plate 25 are sequentially formed on the back side of the first polymer film board 21. Additionally, ITO electrodes (wiring pattern) 32 and an orientation film 33 are formed on the front side of a second polymer film board 31. The ITO electrodes 32 are arranged in a stripe pattern having a uniform pitch. A polarization plate 34 is formed on the back side of the second polymer film board 31.

Each of the first and second polymer film boards 21 and 31 is made of a material such as polycarbonate (PC), polyethersulfon (PES) or a polysulfon (PS), and has a thickness of 0.1 mm to 0.2 mm. Additionally, a seal member 26 is provided on the front side of the first polymer film board 21. Gap members (spacers) 35 are arranged on the front side of the second polymer film board 31 at uniform intervals.

Hereinafter, the arrangement of the first polymer film board 21 and the parts formed on the first polymer film board 21, such as the ITO electrodes 22, the orientation film 23, the seal member 26, the polarization plate 24 and the reflection plate 25, is referred to as a lower-side board 20. Additionally, the arrangement of the second polymer film board 31 and the parts formed on the second polymer film board 31, such as the ITO electrodes 32, the orientation film 33, the gap members 35 and the polarization plate 34, is referred to as an upper-side board 30.

In the example shown in FIG. 8 and FIG. 9, the lower-side board 20 and the upper-side board 30 are bonded by a thermo-compression bonding so that the ITO electrodes 22 of the lower-side board 20 are opposite to and perpendicular to the ITO electrodes of the upper-side board 30. Additionally, a part of each of the ITO electrodes 22 and a part of each of the ITO electrodes 32 are exposed as shown in the figures. The thus-formed structure is used as a board for a liquid crystal display element. That is, the lower-side board 20 and the upper-side board 30 are opposed to each other by a predetermined distance defined by a thickness of the gap members 35. Additionally, outer edges of the lower-side board 20 and the upper-side board 30 are sealed by the seal member 26 except for a liquid crystal injecting portion 40 being maintained unsealed.

In the thus-constructed board for a liquid crystal display board, a liquid crystal is injected through the liquid crystal injecting portion 40 into a space defined by the lower-side board 20 and the upper-side board 30 and the seal member 26. After the liquid crystal is injected, the liquid crystal injecting portion 40 is sealed.

In the thus-produced liquid crystal display element, each of the intersections of the ITO electrodes 22 and ITO electrodes 32 serves as each dot of the liquid crystal display screen. That is, by providing drive signals to the exposed portions of the ITO electrodes 22 and the ITO electrodes 32, an orientation of the liquid crystal at each intersection of the ITO electrodes 22 and the ITO electrodes 32 is changed so that a character or an image can be displayed on the screen when viewed from the side of the upper-side board 30.

In FIGS. 8 and 9, the exposed portion of the ITO electrodes 22 serve as terminal electrodes 42 for external connection, and the exposed portion of the ITO electrodes 32 serve as terminal electrodes 43 for external connection. Thus, terminal electrodes of a flexible circuit extending from a drive circuit device are connected to the terminal electrodes 42 and 43, respectively, for providing the drive signals to the liquid crystal display device. That is, terminal electrodes of a drive circuit board are connected by a thermo-compression bonding.

It should be noted that, in the liquid crystal display device shown in FIGS. 8 and 9, the terminal electrodes 42 are formed on the lower-side board 20 and the terminal electrodes 43 are formed on the upper-side board 30. However, both the terminal electrodes 42 and 43 may be provided on one of the lower-side board 20 and the upper-side board 30. This structure may be referred to as a one-side electrode connection type.

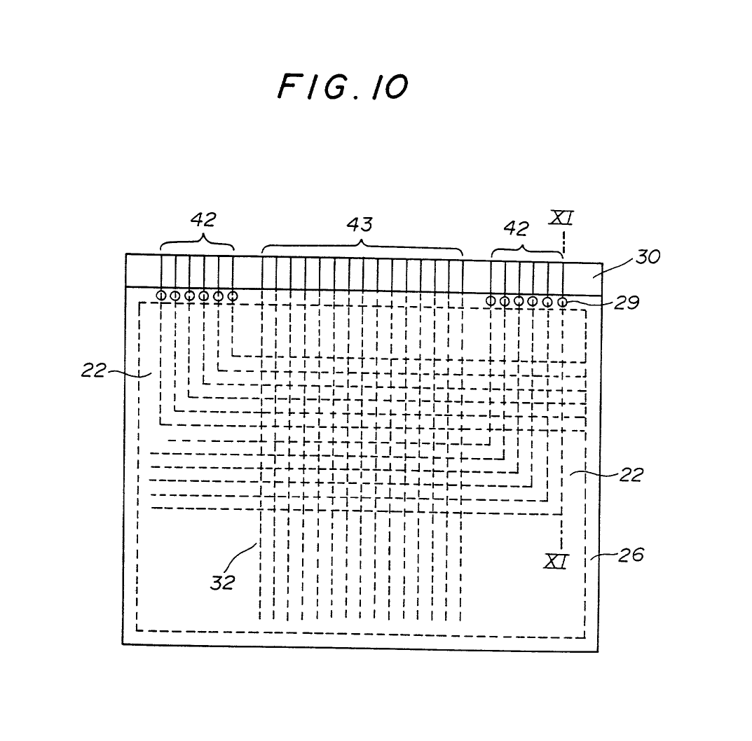

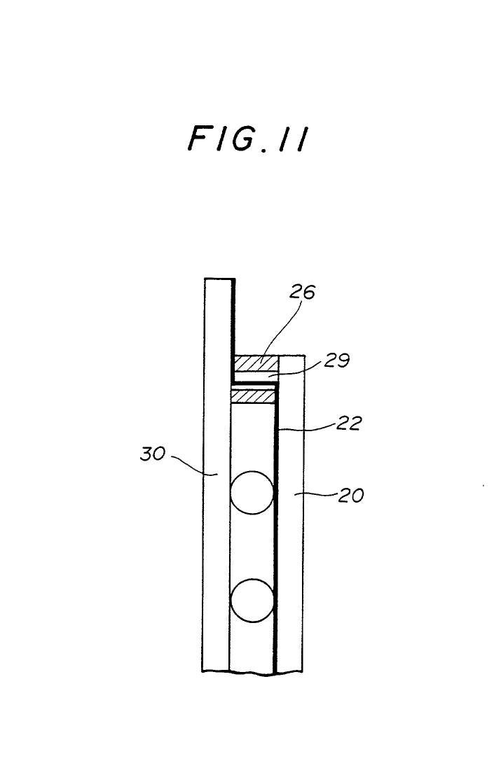

FIG. 10 is a plan view of a liquid crystal display device of the one-side electrode connection type. FIG. 11 is a cross-sectional view of the liquid crystal display device taken along a line XI-XI of FIG. 10. In FIGS. 10 and 11, parts that are the same as the parts shown in FIGS. 8 and 9 are given the same reference numerals, and descriptions thereof will be omitted. In the liquid crystal display element shown in FIG. 10, the ITO electrodes 22 of the lower-side board 20 are turned so that the turned portion of the ITO electrodes 22 are perpendicular to the ITO electrodes 32. Then, the turned portion of the ITO electrodes is extended to the upper-side board 30 through connection openings (through holes) 29. Accordingly, the ends of the ITO electrodes are lead to the front side of the upper-side board 30 on which the ITO electrodes 32 are formed. That is, both the terminal electrodes 42 of the lower-side board 20 and the terminal electrodes of the upper-side board 30 are formed on the upper-side board 30.

As mentioned above, the electrode terminals of a flexible wiring board of a drive circuit device are connected to the terminal electrodes 42 and 43 of either the liquid crystal display element of the type shown in FIG. 8 or the type shown in FIG. 10. The connection of the electrode terminals of the flexible wiring board is achieved by using the anisotropic conductive adhesive 11 according to the present invention by a thermo-compression bonding method.

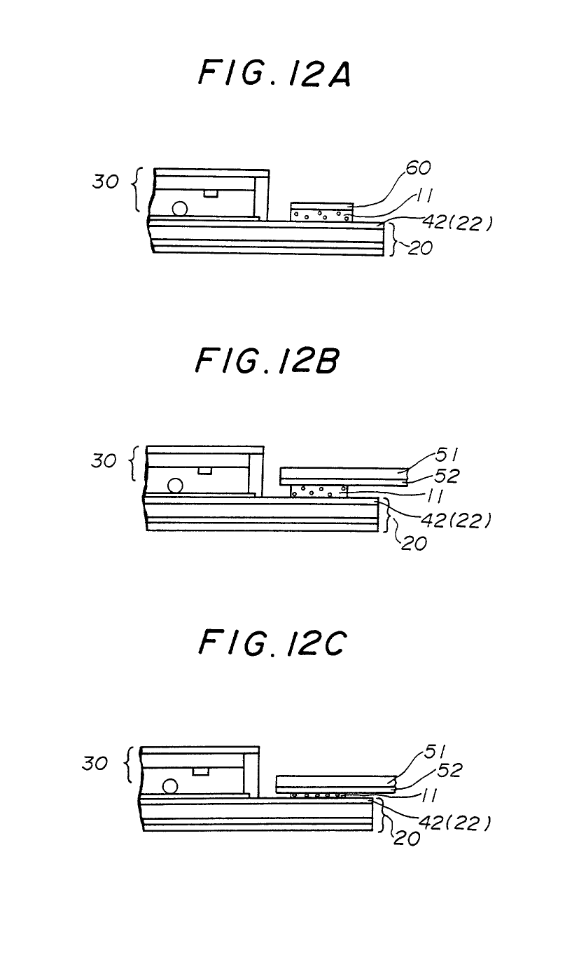

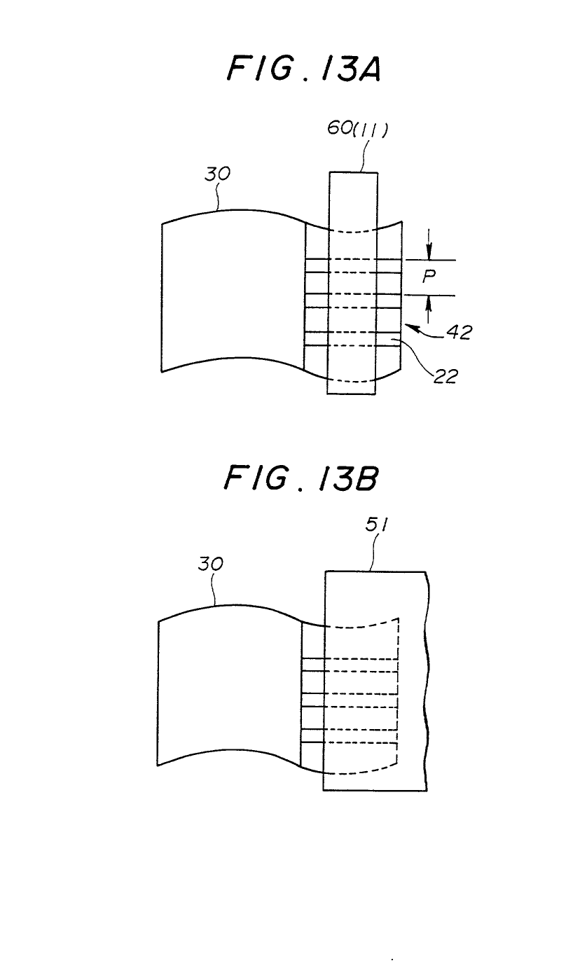

FIGS. 12A, 12B and 12C are illustrations for explaining a method for bonding terminal electrodes of a liquid crystal display device to terminal electrodes of a flexible wiring board of a drive circuit device by using the anisotropic conductive adhesive 11 according to the present invention. FIG. 13A is a plan view of a part shown in FIG. 12A. FIG. 13B is a plan view of a part shown in FIG. 12B.

It should be noted that, in FIGS. 12A, 12B and 12C, terminal electrodes 52 formed on a drive circuit board 51 are bonded to the terminal electrodes 42 of the lower-side board 20. Additionally, as shown in FIG. 12A, the anisotropic conductive adhesive 11 is provided in the form of a film tape wound on a drum, and is previously provided with a separator 60.

Referring to FIG. 12A, the anisotropic conductive adhesive 11 according to the present invention is placed on the terminal electrodes 42 of the lower-side board 20. Then, the anisotropic conductive adhesive 11 is bonded to the terminal electrodes 42 by heating at a temperature of 60° C. to 80° C. Then, the separator 60 is removed from the anisotropic conductive adhesive 11.

Thereafter, referring to FIG. 12B, the terminal electrodes 52 are placed on the terminal electrodes 42 at exact positions with the anisotropic conductive adhesive 11 interposed therebetween. Then, the terminal electrodes 52 are bonded to the terminal electrodes 42 by a thermo-compression bonding method. The thermo-compression bonding process may be performed by two steps. In the example shown in FIGS. 12A, 12B and 12C, the thermo-compression bonding process is performed by heating at a temperature of 110° C. to 150° C. (preferably about 130° C.) for about 5 seconds to 15 seconds (preferably about 10 seconds) while pressing with a pressure of 2 MPa to 4 MPa (preferably 3 MPa).

According to the above-mentioned thermo-compression bonding process, the anisotropic conductive adhesive 11 has the state shown in FIG. 7. That is, the terminal electrodes 52 are electrically connected to the terminal electrodes 42 by the conductive particles 1 (1a) which are positioned between the terminal electrodes 52 and the terminal electrodes 42 and are crushed by the pressure applied by the terminal electrodes 52 and the terminal electrodes 42. On the other hand, no pressure is applied to the conductive particles 1 (1b) positioned in a space other than the space between the terminal electrodes 52 of the drive circuit device and the terminal electrodes 42 of the lower-side board 20 of the liquid crystal display device. Accordingly, the terminal electrodes 52 provided on the same side are well-insulated after the bonding, and the terminal electrodes 42 provided on the same side are also well-insulated after the bonding. Thus, the anisotropic conductive bonding can be achieved.

In the anisotropic conductive adhesive 11, since the conductive particles 1 are contained therein have the compressive deformation characteristic C1 shown in FIG. 2, the conductive particles 1 crush at a pressure smaller than a pressure applied in a conventional pressing and heating process. Specifically, when the terminal electrodes 52 of the drive circuit board 51 are bonded to the terminal electrodes 42 of the lower-side board 20 via the anisotropic conductive adhesive 11 by a thermo-compression bonding method, a degree of compression deformation of the conductive particles 1 contained in the anisotropic conductive adhesive 11 is 20% to 80%.

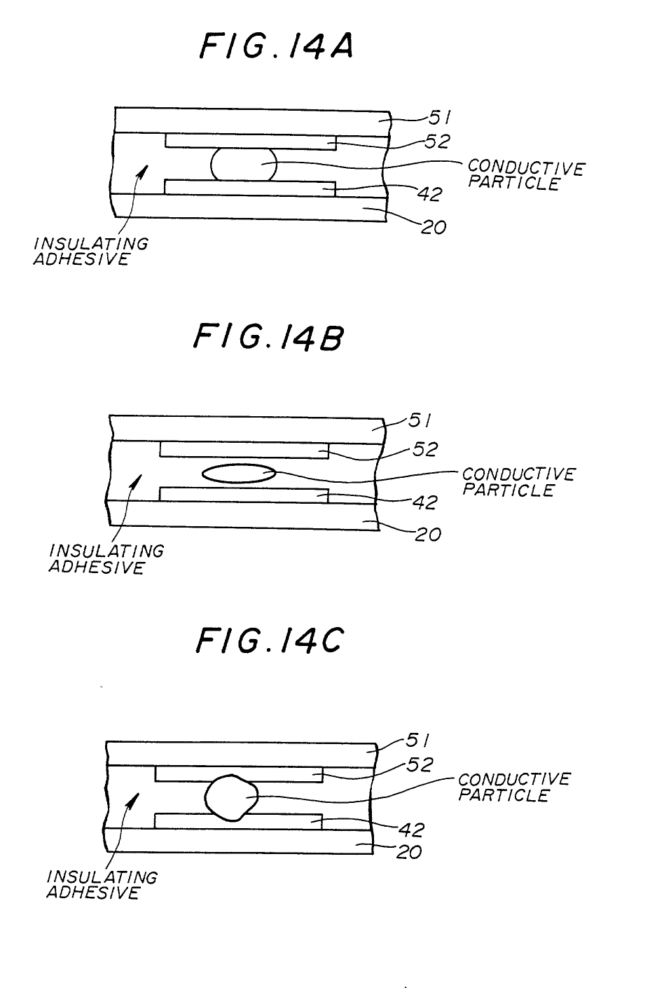

FIGS. 14A, 14B and 14C are illustrations for showing a state of a conductive particle when the terminal electrodes 52 of the drive circuit board 51 are bonded to the terminal electrodes 42 of the lower-side board 20 by a thermo-compression bonding method. FIG. 14A shows a case in which a conductive particle having the compression deformation characteristic C1 shown in FIG. 2 is used; FIG. 14B shows a case in which a conductive particle having the compression deformation characteristic C2 shown in FIG. 2 is used; FIG. 14C shows a case in which a conductive particle having the compression deformation characteristic C3 shown in FIG. 2 is used.

In the case shown in FIG. 14B, that is, when the conductive particle having the compression deformation characteristic C2 is used, the conductive particle easily deforms during a thermo-compression bonding process since the conductive particle has a characteristic of a soft elastic sphere. Accordingly, the insulating adhesive (binder) 12 may remain between the conductive material and each of the terminal electrodes 52 of the drive circuit board 51 and the terminal electrodes 42 of the lower-side board 20. That is, a probability of direct contact between the conductive particle and each of the terminal electrodes 52 of the drive circuit board 51 and the terminal electrodes 42 of the lower-side board 20 is decreased. Thus, a good conductivity may not be achieved.

In the case shown in FIG. 14C, that is, when the conductive particle having the compression deformation characteristic C3 is used, the conductive particle easily deforms during a thermo-compression bonding process since the conductive particle has a characteristic of a hard elastic sphere. The characteristic of a hard elastic sphere is maintained until a compression force reaches a considerably large value. Accordingly, the conductive particle does not crush until the compression force reaches a considerably large value when the terminal electrodes 52 of the drive circuit board 51 are bonded to the terminal electrodes 42 of the lower-side board 20 via the anisotropic conductive adhesive 11 by a thermo-compression bonding method. Thus, the conductive particle 1 does not crush, and thereby the board 20 or the terminal electrodes 42 and 52 may be deformed or damaged. For example, the ITO electrodes may be cracked.

On the other hand, in the case shown in FIG. 14A, that is, when the conductive particle 1 having the compression deformation characteristic C1 is used, the conductive particle easily deforms in the initial stage of the thermo-compression bonding process since the conductive particle has a characteristic of a hard elastic sphere until the compression force reaches a certain level. Accordingly, a probability of the conductive particle 1 making direct contact with the terminal electrodes 52 and 42 is increased. Additionally, since the conductive particle 1 crushes when the compression force reaches a certain level, a contact area between the conductive particle 1 and each of the terminal electrodes 42 and 52 can be increased without causing a deformation or damage in the board 20 or the terminal electrodes 42 and 52.

As mentioned above, by using the anisotropic conductive adhesive 11 containing the conductive particle 1 according to the present invention, the conductive bonding between the terminal electrodes 42 of the lower-side board 20 and the terminal electrodes 52 of the drive circuit board 51 can be very reliable.

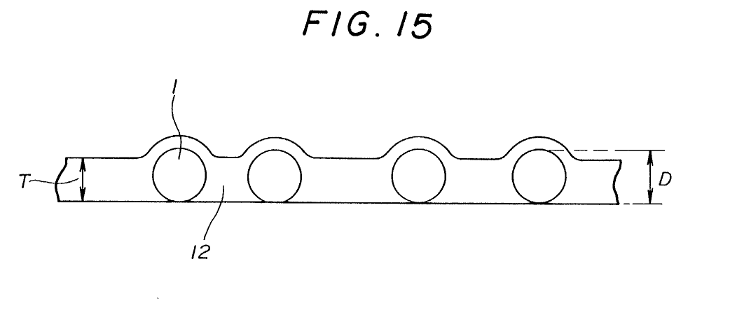

Additionally, when the anisotropic conductive adhesive 11 containing the conductive particle 1 is used, it is preferable to set a diameter D of the conductive particle 1 and a thickness T of the insulating adhesive 12 so as to satisfy a relationship D≧T, as shown in FIG. 15.

Specifically, the thickness T of the insulating adhesive 12 is preferably set to a value so that a space between the terminal electrodes 42 of the lower-side board 20 and the terminal electrodes 52 of the drive circuit board 51 is almost filled by the insulating adhesive 12 and an excessive amount of the insulating adhesive 12 does not overflow from the space.

As mentioned above, when the diameter D of the conductive particle 1 and the thickness T of the insulating adhesive 12 are determined to satisfy the relationship D≧T, a smaller amount of the insulating adhesive 12 remains in the space between the terminal electrodes 42 and 52. Accordingly, a more reliable anisotropic conductive bonding between the terminal electrodes 42 and 52 can be achieved. Additionally, an excessive amount of the insulating adhesive 12 is prevented from overflowing out of the board when the thermo-compression bonding is performed.

As mentioned above, the conductive particle 1 contained in the anisotropic conductive adhesive 11 has a characteristic of a hard elastic sphere at the initial stage in which a compression force is relatively low, and thereby an amount of the insulating adhesive 12 remaining in the space between the conductive particle 1 and each of the terminal electrodes 42 and 52 is small. Thus, the electric connection between the terminal electrodes 52 of the drive circuit board 51 and the terminal electrodes 42 of the lower-side board 20 can be reliably achieved. Additionally, since the conductive particle 1 according to the present invention rapidly crushes when the compression force exceeds a relatively small initial value, the conductive particle 1 does not cause a deformation or damage of the board 20 or the electrodes 42 and 52 when the board 20 is made of a relatively soft material such as a polymer film. Additionally, since the conductive particle 1 crushes and deforms permanently after the initial stage is passed, a contact area between the conductive particle 1 and each of the terminal electrodes 42 and 52 can be increased without causing a deformation or damage to the board 20 or the terminal electrodes 42 and 52. As a result, an electric resistance (contact resistance) between the terminal electrodes 52 of the drive circuit board 51 and the terminal electrodes 42 of the lowerside board 20 via the conductive particle 1 can be reduced.

That is, by using the anisotropic conductive adhesive 11 containing the conductive particle 1 according to the present invention, a wide contact area between the terminal electrodes and the conductive particle 1 and a possibility of generation of cracks in the ITO electrodes of the polymer film board can be greatly reduced. Accordingly, the anisotropic conductive bonding between the terminal electrodes 42 of the lower-side board 20 and the terminal electrodes 52 of the drive circuit board 51 can be reliably achieved.

It should be noted that the above-mentioned example is a case in which the terminal electrodes 52 of the drive circuit board 51 are bonded to the terminal electrodes 42 for external connection formed on the lower-side board 20 by the thermo-compression bonding method using the anisotropic conductive adhesive 11. However, the above-mentioned advantages according to the present invention can be achieved when the terminal electrodes 52 of the drive circuit board 51 are bonded to the terminal electrodes 43 of the upper-side board 30 shown in FIGS. 8 and 9. Additionally, the above-mentioned advantages according to the present invention can be achieved when the terminal electrodes 52 of the drive circuit board 51 are bonded to the terminal electrodes 42 and 43 formed on the upper-side board 30 shown in FIG. 10.

A description will now be given of a second embodiment of the present invention.

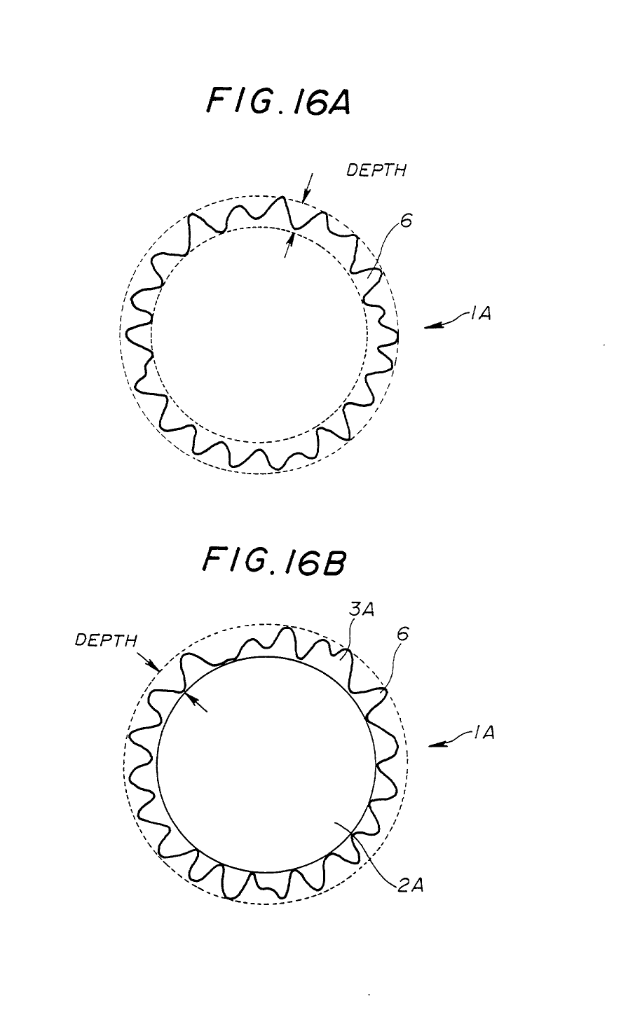

FIG. 16A is an illustration of a conductive particle 1A according to the second embodiment of the present embodiment. The conductive particle 1A shown in FIG. 16A has the same structure as the conductive particle 1 according to the above-mentioned first embodiment of the present invention except for an irregularity (surface roughness) 6 provided on an outer surface thereof. Similar to the conductive particle 1, the conductive particles 1A are to be dispersed in the insulating adhesive 12 so as to produce an anisotropic conductive adhesive that is used for bonding conductive members by a thermo-compression bonding method. The irregularity 6 is formed with a sufficient depth so that the conductive particle 1A can thrust through the insulating adhesive 12 and reaches the conductive member when a pressure is applied to the anisotropic conductive adhesive during the thermo-compression bonding process.

When the conductive particle 1A is used for producing the anisotropic conductive adhesive, the conductive particle 1A preferably has an average diameter of 2 μm to 50 μm, more preferably 5 μm to 30 μm. In such a case, the depth of the irregularity 6 of the surface of the conductive particle 1A is 0.05 μm to 2 μm. Additionally, a density of peaks of the irregularity 6 preferably is 1,000 pieces/mm² to 500,000 pieces/mm².

More specifically, the conductive particle 1A comprises, as shown in FIG. 16B, a core particle 2A and a conductive layer 3A formed on a surface of the core particle 2A. The irregularity 6 is defined by an irregularity of the conductive layer 3A. It should be noted that the core particle 2A and the conductive layer 3A can be made of the same materials as the core particle 2 and the conductive layer 3 of the conductive particle 1 according to the first embodiment of the present invention.

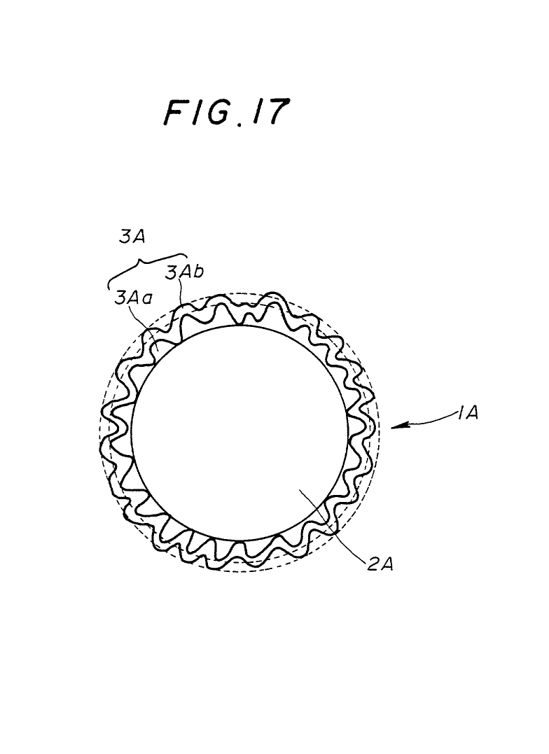

Similar to the conductive layer 3 of the conductive particle 1, the conductive layer 3A preferably comprises a nickel (Ni) layer 3Aa and a gold (Au) layer 3Ab formed on a surface of the nickel layer 3Aa as shown in FIG. 17.

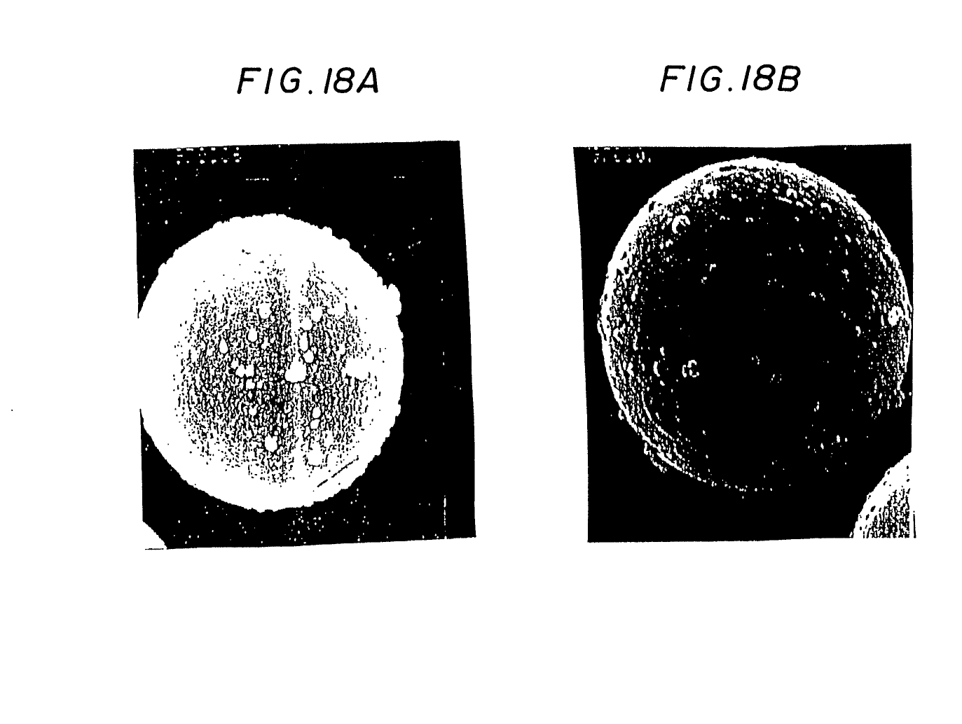

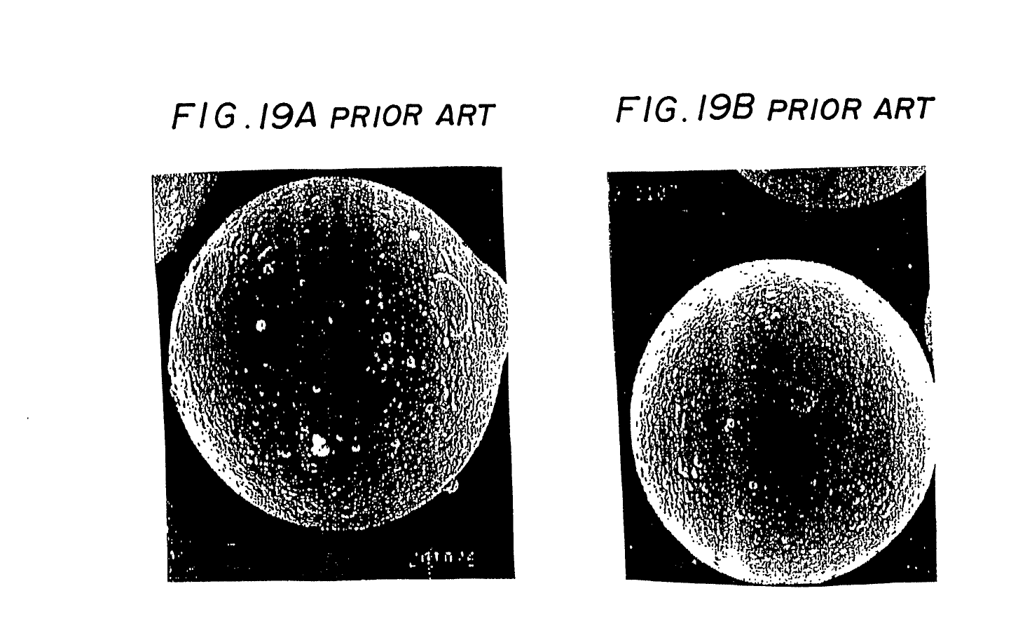

FIGS. 18A and 18B are photographs of an example of the conductive particle 1A. FIGS. 19A and 19B are photographs of a conventional conductive particle having a relatively small irregularity. It should be noted that the conductive particles shown in FIGS. 18A, 18B, 19A and 19B have a diameter of 20 μm, and the photographs were taken by a magnification of 400 times.

The conductive particle 1A shown in FIGS. 18A and 18B comprises the core particle 2A made of polystyrene and the conductive layer 3A including the nickel layer and the gold layer. More specifically, the conductive layer 3A was formed by plating nickel by an electroless nickel plating and further plating gold on the nickel layer by a gold substitution plating. It should be noted that a pretreatment process was performed by increasing a concentration of palladium twice as much as that of a conventional pretreatment. Additionally, the conventional conductive particle shown in FIGS. 18A and 18B was formed by forming a nickel layer by a known electroless nickel plating.

As clearly shown in the photographs of FIGS. 18A and 19B, the depth of the irregularity 6 of the conductive particle 1A is larger than a depth of the irregularity of the conductive particle shown in FIGS. 19A and 19B is are formed by a conventional method. Additionally, a density of peaks of the irregularity 6 of the conductive particle 1A is higher than a density of the irregularity of the conductive particle shown in FIGS. 18A and 18B.

Similar to the conductive particle 1 according to the first embodiment, the conductive particle 1A is particularly used for producing an anisotropic conductive adhesive by dispersing the conductive particles 1A in an insulating adhesive. When a pressure is applied to the thus-formed anisotropic conductive adhesive by being sandwiched between conductive members such as wiring patterns to be bonded, the irregularity 6 of the conductive particle 1A thrusts aside the insulating adhesive so that the conductive particle 1A easily reaches a surface of the conductive members. Accordingly, a reliable electric connection can be obtained between the conductive particle 1A and each of the conductive members (wiring patterns). Thus, the anisotropic conductive adhesive containing the conductive particles 1A according to the second embodiment of the present invention can provide a good conductivity between the conductive members to be bonded.

Additionally, similar to the conductive particle 1 according to the first embodiment of the present invention, the conductive particle 1A may have the compressive deformation characteristic C1 shown in FIG. 2. A method for manufacturing the conductive particle 1A having the compressive deformation characteristic C1 is provided in the description of the first embodiment of the present invention, and a description thereof will be omitted. It should be noted that, similar to the anisotropic conductive adhesive 11 containing the conductive particles 1 according to the first embodiment, the anisotropic conductive adhesive containing the conductive particles 1a is also suitable for bonding terminal electrodes provided in a liquid crystal display device using a polymer film as a base board.

A description will now be given of a third embodiment of the present invention.

The third embodiment of the present invention is directed to an anisotropic conductive adhesive containing conductive particles such as the conductive particle 1 according to the first embodiment of the present invention or the conductive particle 1A according to the second embodiment of the present invention.

Hereinafter, it is supposed that the anisotropic conductive adhesive according to the third embodiment of the present invention comprises the conductive particles 1 and the insulating adhesive 12.

The conductive particle 1 normally has an average diameter of 2 μm to 50 μm, preferably 5 μm to 30 μm. Additionally, a CV value of the conductive particle 1 is preferably less than 20%, more preferably less than 15%. The CV value is a ratio (σ/AV) of a standard deviation σ of diameters of the conductive particles 1 to an average diameter AV of the conductive particles 1 contained (dispersed) in the anisotropic conductive adhesive 11. The CV value preferably is as small as possible. That is, the conductive particles 1 contained in the anisotropic conductive adhesive preferably have as uniform diameter as possible.

The anisotropic conductive adhesive according to the third embodiment of the present invention has a feature in that the conductive particles 1 are dispersed in the insulating adhesive 12 at a predetermined density so that the anisotropic conductive adhesive according to the third embodiment can provide an appropriate anisotropic conductive characteristic.

Specifically, the anisotropic conductive adhesive according to the third embodiment contains the conductive particles 1 at a dispersion density of 300 pieces/mm² to 650 pieces/mm², preferably 320 pieces/mm² to 600 pieces/mm².

Especially, when the anisotropic conductive adhesive is used for bonding the terminal electrodes of a liquid crystal display device as is described in the first embodiment, a diameter of the conductive particle 1 preferably is about 20 μm and a dispersion density preferably is 320 pieces/mm² to 600 pieces/mm².

That is, when the anisotropic conductive adhesive is used for bonding the terminal electrodes of the liquid crystal display element to the terminal electrodes of the flexible wiring board, the conductive particle 1 having a greater diameter causes less generation of cracks in the terminal electrodes such as the terminals of the ITO electrodes. However, if the diameter of the conductive particle 1 is too large, a dispersion density of the conductive particles 1 must be decreased so as to prevent adjacent electrode patterns on the same board from being short-circuited. If the dispersion density of the conductive particles 1 is decreased, considerable deviation may occur in a number of the conductive particles 1 positioned in each space between the terminal electrodes. This may result in difficulty in providing uniform conductive bonding to each terminal electrode. Thus, if the diameter of the conductive particle is too large, it is difficult to achieve a reliable electric resistance between the terminal electrodes.

Especially, when a pitch of the terminal electrodes of the liquid crystal display element is 150 μm to 400 μm, the diameter of the conductive particle 1 preferably is about 20 μm in order to prevent the terminal electrodes from being cracked and from being short-circuited. Additionally, the dispersion density preferably is 320 pieces/mm² to 600 pieces/mm².

Specifically, the above-mentioned range of the dispersion density is defined by an upper limit for preventing a short circuit between adjacent terminal electrodes and a lower limit for maintaining a reliable electric resistance between the electrodes bonded by the anisotropic conductive adhesive. That is, the lower limit corresponds to 320 pieces/mm², and the ipper limit corresponds to 600 pieces/mm². The inventors of the present invention evaluated the upper limit value and the lower limit value by using a liquid crystal display device having terminal electrodes arranged with a pitch of 200 μm. In an evaluation test, a target value of a probability of a short circuit failure between adjacent terminal electrodes on the same board was set to 10⁻⁹ (a failure rate with respect to the display capacity VGA (Video Graphics Array) is 1 ppm). As a result, the upper limit of the dispersion density of the conductive particles 1 was predicted to be about 600 pieces/mm². Additionally, it was found that five or more particles are needed to maintain a reliable electric resistance between the terminal electrodes. When a target value of a probability at which a number of particles positioned on each terminal electrode becomes less than five is set to 10⁻⁹, the lower limit value was predicted to be 320 pieces/mm². Accordingly, it was found that a reliable electric connection between the terminal electrodes of the liquid crystal display element and the terminal electrodes of the flexible wiring board is achieved by setting the dispersion density of the conductive particles 1 within the range 320 pieces/mm² to 600 pieces/mm².

Similar to the anisotropic conductive adhesive 11 containing the conductive particle 1 according to the first embodiment, when the anisotropic conductive adhesive containing the conductive particle 1 is used, it is preferable to set a diameter D of the conductive particle 1 and a thickness T of the insulating adhesive 12 so as to satisfy a relationship D≧T.

Specifically, the thickness T of the insulating adhesive is preferably set to a value so that a space between the terminal electrodes opposite to each other is almost filled by the insulating adhesive and an excessive amount of the insulating adhesive does not overflow from the space.

As mentioned above, when the diameter D of the conductive particle 1 and the thickness T of the insulating adhesive 12 are determined to satisfy the relationship D≧T, a smaller amount of the insulating adhesive 12 remains in the space between the terminal electrodes. Accordingly, a more reliable anisotropic conductive bonding between the terminal electrodes can be achieved. Additionally, an excessive amount of the insulating adhesive 12 is prevented from overflowing out of the board when the thermo-compression bonding is performed.

Similar to the anisotropic conductive adhesive according to the first embodiment of the present invention, the anisotropic conductive adhesive according to the present embodiment can be provided in the form of a sheet or film.

The inventors of the present invention evaluated an applicable range of the thickness T of the insulating adhesive 12 when a polymer film is used for a base board of the liquid crystal display board and the terminal electrodes of the flexible wiring board to be connected is 22 μm. As a result, it was found that a reliable electric connection can be obtained when a low-resistance polymer film is used. However, it was found that the electric resistance between the bonded electrodes is high when a high-resistance polymer film is used. This indicated that a contacting surface between the conductive particle 1 and the terminal electrodes must be increased when the high-resistance polymer film is used. However, when the anisotopic conductive adhesive is provided as a film tape wound on a drum, a tolerance of a thickness of the film tape is ±2 μm. Accordingly, a reliability of electrical connection with respect to the high-resistance polymer film can be maintained if the thickness of the anisotropic conductive adhesive (film) is within tolerance in a manufacturing process.

As mentioned above, a reliable electric connection was obtained for the low-resistance polymer film, and also a reliable connection was obtained for the high-resistance polymer film, by appropriately setting the thickness of the anisotropic conductive adhesive even when the thickness of the flexible terminal electrode was 35 μm. Regarding connection to the high-resistance polymer film board, the thickness T of the anisotropic conductive adhesive must be smaller than the diameter D of the conductive particle 1 so as to increase the contacting area. A thickness of 18 μm is suggested for the flexible terminal electrodes.

Specifically, when the thickness of the electrodes is 18 μm, the thickness T of the insulating adhesive 12 is set to 16±3 μm. In such a case, the diameter D of the conductive particle 1 is preferably set to about 20 μm.

Accordingly, the conductive particle 1 used for the anisotropic conductive adhesive is preferably set to 20 μm for the reason that the diameter D of the conductive particle 1 and the thickness T of the anisotropic conductive adhesive 12 must satisfy the relationship D≧T.

The present invention is not limited to the specifically disclosed embodiments, and variations and modifications may be made without departing from the scope of the present invention.

The present application is based on Japanese priority applications No.9-247775 filed on Aug. 28, 1997, No.9-247791 filed on Aug. 28, 1997 and No.9-247798 filed on Aug. 28, 1997, the entire contents of which are hereby incorporated by reference.

What is claimed is:

1. A conductive particle for an anisotropic conductive adhesive, comprising:
a core particle; and
a conductive layer formed on a surface of said core particle,
wherein said conductive particle has a yield point within a range of degree of deformation from 5% to 40%, a modulus of compressive deformation of said conductive particle drastically increasing at said yield point.

2. The conductive particle as claimed in claim 1, wherein when a compressive elastic deformation characteristic K of said conductive particle is defined as K=(3/2^{½})·(S^{-3/2})·(R^{-½})·F, a value of K is 10 to 100 (kgf/mm²) when a degree of compressive deformation of said conductive particle is 40%, where F is a compression force (kgf), S is a compression strain (mm) and R is a radius (mm) of said conductive particle.

3. A conductive particle for an anisotropic conductive adhesive, comprising:
a core particle; and
a conductive layer formed on a surface of said core particle,
wherein said conductive particle shows a characteristic of a hard elastic sphere until a compression force reaches 2 gf/particle to 3 gf/particle at an ordinary temperature, and said conductive particle crushes and begins to plastically deform when the compression force reaches 2 gf/particle to 3 gf/particle.

4. The conductive particle as claimed in claim 3, wherein when a compressive elastic deformation characteristic K of said conductive particle is defined as K=(3/2^{½})·(S^{-½})·(R^{-½})·F, a value of K is 10 to 100 (kgf/mm²) when a degree of compressive deformation of said conductive particle is 40%, where F is a compression force (kgf), S is a compression strain (mm) and R is a radius (mm) of said conductive particle.

5. A conductive particle for an anisotropic conductive adhesive, comprising:
a core particle made of a resin material; and
a conductive layer formed on an entire surface of said core particle, said conductive layer being formed by metal coating,
wherein said core particle has a yield point within a range of a compression force from 2 gf/particle to 3 gf/particle, a modulus of compressive deformation of said conductive particle drastically increasing so that said conductive particle starts to crush and plastically deform at said yield point.

6. The conductive particle as claimed in claim 5, wherein when a compressive elastic deformation characteristic K of said conductive particle is defined as K=(3/2^{½})·(S^{-3/2})·(R^{-½})·F, a value of K is 10 to 100 (kgf/mm²) when a degree of compressive deformation of said conductive particle is 40%, where F is a compression force (kgf), S is a compression strain (mm) and R is a radius (mm) of said conductive particle.

7. An anisotropic conductive adhesive comprises:
an insulating adhesive; and
conductive particles dispersed in said insulating adhesive,
wherein each of the conductive particles comprises:
a core particle; and
a conductive layer formed on a surface of said core particle,
wherein said conductive particle has a yield point within a range of degree of deformation from 5% to 40%, a modulus of compressive deformation of said conductive particle drastically increasing at said yield point.

8. The anisotropic conductive adhesive as claimed in claim 7, wherein said anisotropic conductive adhesive is formed as a film material, and a relationship between a diameter D of said conductive particle and a thickness T of said film material is represented by D≧T.

9. The anisotropic conductive adhesive as claimed in claim 7, wherein an average diameter of said conductive particles is within a range from 2 μm to 30 μm, and a CV value of said conductive particles is less than 20%.

10. The anisotropic conductive adhesive as claimed in claim 7, wherein said anisotropic conductive adhesive is used for bonding a terminal electrode of a liquid crystal display element using a resin board to a terminal electrode of a flexible wiring board by thermo-compression bonding, and a degree of compression deformation of said conductive particles when the thermo-compression bonding is performed is within a range from 20% to 80%.

11. An anisotropic conductive adhesive comprises:
an insulating adhesive; and
conductive particles dispersed in said insulating adhesive,
wherein each of the conductive particles comprises:
a core particle; and
a conductive layer formed on a surface of said core particle,
wherein said conductive particle shows a characteristic of a hard elastic sphere until a compression force reaches 2 gf/particle to 3 gf/particle at an ordinary temperature, and said conductive particle crushes and begins to plastically deform when the compression force reaches 2 gf/particle to 3 gf/particle.

12. The anisotropic conductive adhesive as claimed in claim 11, wherein said anisotropic conductive adhesive is formed as a film material, and a relationship between a diameter D of said conductive particle and a thickness T of said film material is represented by D≧T.

13. The anisotropic conductive adhesive as claimed in claim 11, wherein an average diameter of said conductive particles is within a range from 2 μm to 30 μm, and a CV value of said conductive particles is less than 20%.

14. The anisotropic conductive adhesive as claimed in claim 11, wherein said anisotropic conductive adhesive is used for bonding a terminal electrode of a liquid crystal display element using a resin board to a terminal electrode of a flexible wiring board by thermo-compression bonding, and a degree of compression deformation of said conductive particles when the thermo-compression bonding is performed is within a range from 20% to 80%.

15. An anisotropic conductive adhesive comprises:
an insulating adhesive; and
conductive particles dispersed in said insulating adhesive,
wherein each of the conductive particles comprises:
a core particle made of a resin material; and
a conductive layer formed on an entire surface of said core particle, said conductive layer being formed by metal coating,
wherein said core particle has a yield point within a range of a compression force from 2 gf/particle to 3 gf/particle, a modulus of compressive deformation of said conductive particle drastically increasing so that said conductive particle starts to crush and plastically deform at said yield point.

16. The anisotropic conductive adhesive as claimed in claim 15, wherein said anisotropic conductive adhesive is formed as a film material, and a relationship between a diameter D of said conductive particle and a thickness T of said film material is represented by D≧T.

17. The anisotropic conductive adhesive as claimed in claim 15, wherein an average diameter of said conductive particles is within a range from 2 μm to 30 μm, and a CV value of said conductive particles is less than 20%.

18. The anisotropic conductive adhesive as claimed in claim 15, wherein said anisotropic conductive adhesive is used for bonding a terminal electrode of a liquid crystal display element using a resin board to a terminal electrode of a flexible wiring board by thermo-compression bonding, and a degree of compression deformation of said conductive particles when the thermo-compression bonding is performed is within a range from 20% to 80%.

19. A liquid crystal display device comprises:
a liquid crystal display element having a terminal electrode for external connection, said liquid crystal display element using a resin board;
a flexible wiring board having a terminal electrode bonded to said terminal electrode of said liquid crystal display element; and
an anisotropic conductive adhesive for bonding said terminal electrode of said flexible wiring board to said terminal electrode of said liquid crystal display element,
wherein said anisotropic conductive adhesive comprises:
an insulating adhesive; and
conductive particles dispersed in said insulating adhesive,
wherein each of the conductive particles comprises:
a core particle; and
a conductive layer formed on a surface of said core particle,
wherein said conductive particle has a yield point within a range of degree of deformation from 5% to 40%, a modulus of compressive deformation of said conductive particle drastically increasing at said yield point.

20. A liquid crystal display device comprises:
a liquid crystal display element having a terminal electrode for external connection, said liquid crystal display element using a resin board;
a flexible wiring board having a terminal electrode bonded to said terminal electrode of said liquid crystal display element; and
an anisotropic conductive adhesive for bonding said terminal electrode of said flexible wiring board to said terminal electrode of said liquid crystal display element,
wherein said anisotropic conductive adhesive comprises:
an insulating adhesive; and
conductive particles dispersed in said insulating adhesive,
wherein each of the conductive particles comprises:
a core particle; and
a conductive layer formed on a surface of said core particle,
wherein said conductive particle shows a characteristic of a hard elastic sphere until a compression force reaches 2 gf/particle to 3 gf/particle at an ordinary temperature, and said conductive particle crushes and begins to plastically deform when the compression force reaches 2 gf/particle to 3 gf/particle.

21. A liquid crystal display device comprises:
a liquid crystal display element having a terminal electrode for external connection, said liquid crystal display element using a resin board;
a flexible wiring board having a terminal electrode bonded to said terminal electrode of said liquid crystal display element; and
an anisotropic conductive adhesive for bonding said terminal electrode of said flexible wiring board to said terminal electrode of said liquid crystal display element,
wherein said anisotropic conductive adhesive comprises:
an insulating adhesive; and
conductive particles dispersed in said insulating adhesive,
wherein each of the conductive particles comprises:
a core particle made of a resin material; and
a conductive layer formed on an entire surface of said core particle, said conductive layer being formed by metal coating,
wherein said core particle has a yield point within a range of a compression force from 2 gf/particle to 3 gf/particle, a modulus of compressive deformation of said conductive particle drastically increasing so that said conductive particle starts to crush and plastically deform at said yield point.

22. A conductive particle for an anisotropic conductive adhesive, comprising:
a particle body; and
an irregularity formed on a surface of said particle body,
wherein said conductive particle is provided in an insulating adhesive so as to produce the anisotropic conductive adhesive used for conductively bonding a plurality of conductive members; and
a degree of the irregularity formed on the surface of the particle body is sufficient for eliminating the insulating adhesive between said conductive particle and each of the conductive members so that said conductive particle contacts each of said conductive members when the anisotropic conductive adhesive is subjected to a predetermined pressure during a curing process of the anisotropic conductive adhesive.

23. The conductive particle as claimed in claim 22, wherein the irregularity has a depth ranging from 0.05 μm to 2 μm, and a density of peaks of the irregularity is 1,000 peaks/mm² to 500,000 peaks/mm².

24. The conductive particle as claimed in claim 22, wherein said particle body comprises:
a particle core; and
a conductive layer formed on said particle core,
wherein the irregularity is defined by a surface roughness of said conductive layer.

25. The conductive particle as claimed in claim 22, wherein said conductive particle shows a characteristic of a hard elastic sphere until a compression force reaches 2 gf/particle to 3 gf/particle at an ordinary temperature, and said conductive particle crushes and begins to plastically deform when the compression force reaches 2 gf/particle to 3 gf/particle.

26. An anisotropic conductive adhesive comprises:
an insulating adhesive; and
conductive particles dispersed in said insulating adhesive,
wherein each of the conductive particles comprises:
a particle body; and
an irregularity formed on a surface of said particle body,
wherein said conductive particle is provided in an insulating adhesive so as to produce the anisotropic conductive adhesive used for conductively bonding a plurality of conductive members; and
a degree of the irregularity formed on the surface of the particle body is sufficient for eliminating the insulating adhesive between said conductive particle and each of the conductive members so that said conductive particle contacts each of said conductive members when the anisotropic conductive adhesive is subjected to a predetermined pressure during a curing process of the anisotropic conductive adhesive.

27. The anisotropic conductive adhesive as claimed in claim 26, wherein said anisotropic conductive adhesive is formed as a film material, and a relationship between a diameter D of said conductive particle and a thickness T of said film material is represented by D>T.

28. The anisotropic conductive adhesive as claimed in claim 26, wherein an average diameter of said conductive particles is within a range of 2 μm to 30 μm, and a CV value of said conductive particles is less than 20%.

29. The anisotropic conductive adhesive as claimed in claim 26, wherein said anisotropic conductive adhesive is used for bonding a terminal electrode of a liquid crystal display element using a resin board to a terminal electrode of a flexible wiring board by performing thermo-compression bonding, and a degree of compression deformation of said conductive particles when the thermo-compression bonding is performed is within a range from 20% to 80%.

30. A liquid crystal display device comprises:
a liquid crystal display element having a terminal electrode for external connection, said liquid crystal display element using a resin board;
a flexible wiring board having a terminal electrode bonded to said terminal electrode of said liquid crystal display element; and
an anisotropic conductive adhesive for bonding said terminal electrode of said flexible wiring board to said terminal electrode of said liquid crystal display element,
wherein said anisotropic conductive adhesive comprises:
an insulating adhesive; and
conductive particles dispersed in said insulating adhesive,
wherein each of the conductive particles comprises:
a particle body; and
an irregularity formed on a surface of said particle body,
wherein said conductive particle is provided in an insulating adhesive so as to produce the anisotropic conductive adhesive used for conductively bonding a plurality of conductive members; and
a degree of the irregularity formed on the surface of the particle body is sufficient for eliminating the insulating adhesive between said conductive particle and each of the conductive members so that said conductive particle contacts each of said conductive members when the anisotropic conductive adhesive is subjected to a predetermined pressure during a curing process of the anisotropic conductive adhesive.

31. An anisotropic conductive adhesive comprises:
an insulating adhesive; and
conductive particles dispersed in said insulating adhesive at a dispersion density ranging from 300 pieces/mm² to 650 pieces/mm².

32. The anisotropic conductive adhesive as claimed in claim 31, wherein an average diameter of said conductive particles is within a range from 2 μm to 30 μm.

33. The anisotropic conductive adhesive as claimed in claim 31, wherein each of said conductive particles shows a characteristic of a hard elastic sphere until a compression force reaches 2 gf/particle to 3 gf/particle at an ordinary temperature, and said conductive particle crushes and begins to plastically deform when the compression force reaches 2 gf/particle to 3 gf/particle.

34. The anisotropic conductive adhesive as claimed in claim 31, wherein each of said conductive particles comprises:
a particle body; and
an irregularity formed on a surface of said particle body,
wherein each of said conductive particles is provided in an insulating adhesive so as to produce said anisotropic conductive adhesive used for conductively bonding a plurality of conductive members; and
a degree of the irregularity formed on the surface of the particle body is sufficient for eliminating the insulating adhesive between said conductive particle and each of the conductive members so that said conductive particle contacts each of said conductive members when said anisotropic conductive adhesive is subjected to a predetermined pressure during a curing process of said anisotropic conductive adhesive.

35. The anisotropic conductive adhesive as claimed in claim 31, wherein said anisotropic conductive adhesive is formed as a film material, and a relationship between a diameter D of said conductive particle and a thickness T of said film material is represented by D≧T.

36. A liquid crystal display device comprises:
a liquid crystal display element having terminal electrodes for external connection, said liquid crystal display element using a resin board;
a flexible wiring board having terminal electrodes bonded to said terminal electrode of said liquid crystal display element; and
an anisotropic conductive adhesive for bonding said terminal electrodes of said flexible wiring board to said terminal electrodes of said liquid crystal display element,
wherein said anisotropic conductive adhesive comprises:
an insulating adhesive; and
conductive particles dispersed in said insulating adhesive at a dispersion density ranging from 300 pieces/mm² to 650 pieces/mm².

37. The liquid crystal display device as claimed in claim 36, wherein pitches of said terminal electrodes of said liquid crystal display device are within a range from 150 μm to 400 μm.

38. A method for manufacturing a liquid crystal display device, comprising the steps of:
preparing an anisotropic conductive adhesive comprising an insulating adhesive and conductive particles dispersed in said insulating adhesive at a dispersion density ranging from 320 pieces/mm² to 600 pieces/mm², said conductive particles having an average diameter of 20 μm; and
bonding terminal electrodes of a liquid crystal display element using a resin board to terminal electrodes of a flexible wiring board by using said anisotropic conductive adhesive and performing thermo-compression bonding.

39. The method as claimed in claim 38, wherein said terminal electrodes of said liquid crystal display element are arranged with pitches ranging from 150 μm to 400 μm.

40. The method as claimed in claim 38, wherein a thickness of said terminal electrodes of said flexible wiring board is 18 μm, and a thickness of said anisotropic conductive adhesive is 16±3 μm measured before the thermo-compression bonding is performed.
